(19) United States
(12) Patent Application Publication
(10) Pub. No.: US 2024/0102821 A1
(43) Pub. Date: Mar. 28, 2024

(54) OFFLINE MAPS

(71) Applicant: Apple Inc., Cupertino, CA (US)

(72) Inventors: Leo Emile Jean Pierre VALLET, Culver City, CA (US); Victor BRILON, Mountain View, CA (US); William N. DANNER, Santa Cruz, CA (US)

(21) Appl. No.: 18/473,242

(22) Filed: Sep. 23, 2023

Related U.S. Application Data
(60) Provisional application No. 63/377,016, filed on Sep. 24, 2022.

(51) Int. Cl. G01C 21/36

(52) U.S. Cl. CPC G01C 21/3673; G01C 21/3605

(57) ABSTRACT

In some embodiments, an electronic device proactively obtains and locally store map data associated with one or more portions of the route for offline use. In some embodiments, an electronic device presents one or more suggested maps for download based on a history of user interaction with the electronic device. In some embodiments, the electronic device downloads a suggested map and one or more supplemental maps associated with the suggested map.

### CROSS-REFERENCE TO RELATED APPLICATIONS

This application claims the benefit of U.S. Provisional Application No. 63/377,016, filed Sep. 24, 2022, the content of which is herein incorporated by reference in its entirety for all purposes.

### FIELD OF THE DISCLOSURE

This relates generally to user interfaces associated with mapping applications for offline use.

### BACKGROUND OF THE DISCLOSURE

User interaction with electronic devices has increased significantly in recent years. These devices can be devices such as computers, tablet computers, televisions, multimedia devices, mobile devices, and the like. In some circumstances, users wish to use devices to facilitate presentation of maps using offline data.

### SUMMARY OF THE DISCLOSURE

Some embodiments described in this disclosure are directed to one or more electronic devices that detect, via the one or more input devices, a first user input corresponding to a request to initiate navigation along a route. Some embodiments described in this disclosure are directed to one or more electronic devices that proactively obtain and locally store map data associated with one or more portions of the route for offline use. Some embodiments described in this disclosure are directed to one or more electronic devices using a history of user interaction with the one or more electronic devices to suggest one or more primary maps that are respectively associated with one or more supplemental maps, and obtaining map data for the one or more primary maps and their respective one or more supplemental maps. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 5I-5N provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein.

FIGS. 6A-6H illustrate exemplary ways of proactively obtaining and using offline map data to navigate along a route in accordance with some embodiments.

FIGS. 7A-7B is a flow diagram illustrating a method of proactively obtaining and using offline map data to navigate along a route in accordance with some embodiments.

FIGS. 8A-8N illustrate exemplary ways of obtaining map data associated with a primary map and one or more supplemental maps in accordance with some embodiments.

FIG. 9 is a flow diagram illustrating a method of obtaining map data associated with a primary map and one or more supplemental maps in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices to obtain map data. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

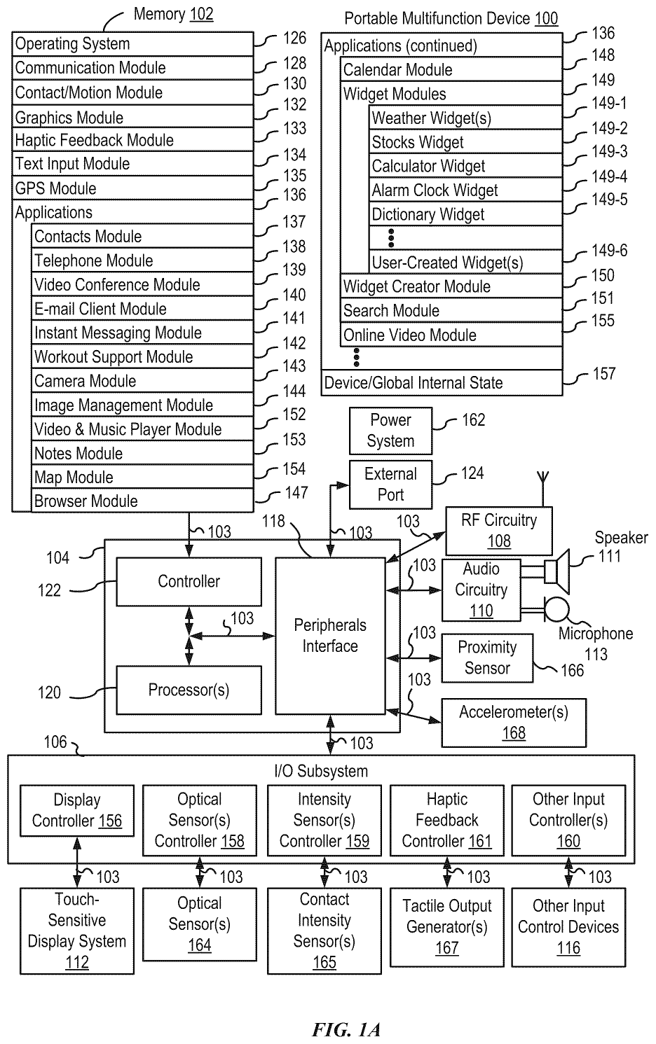

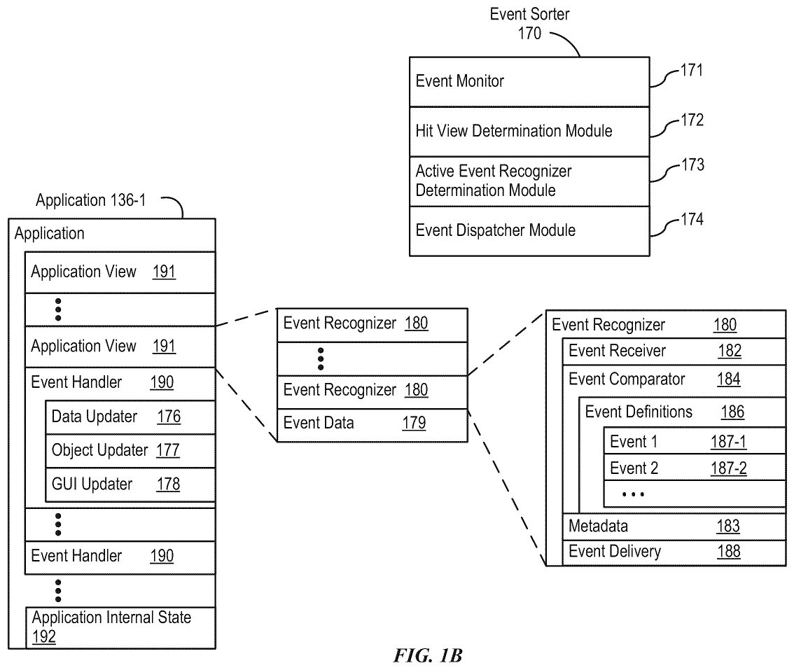

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

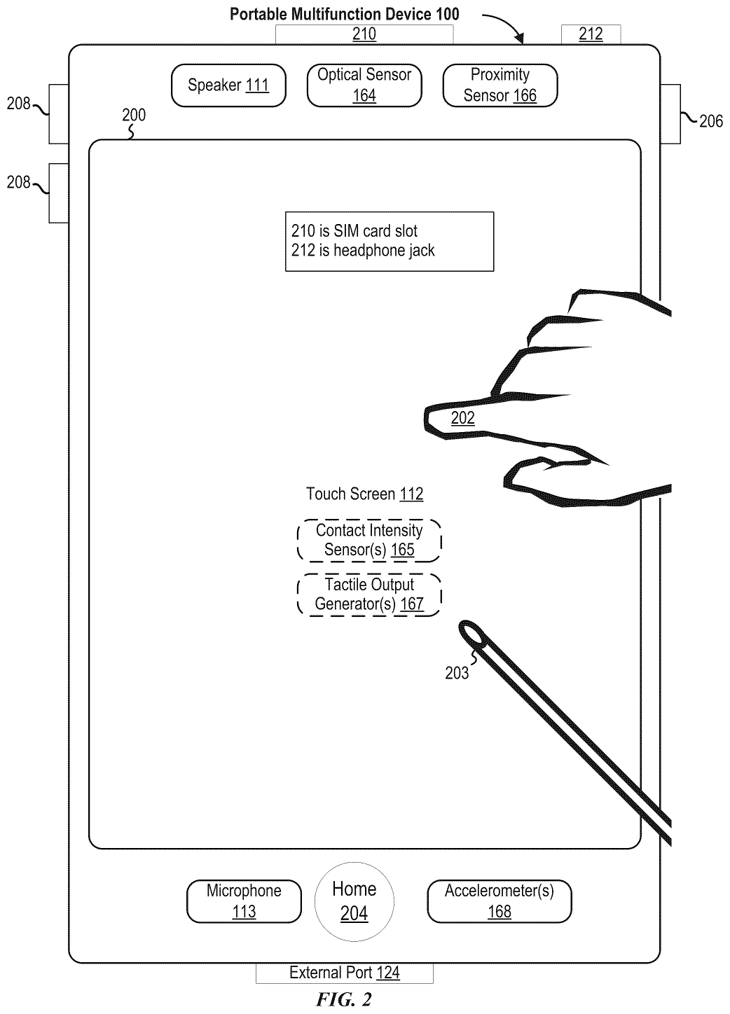

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

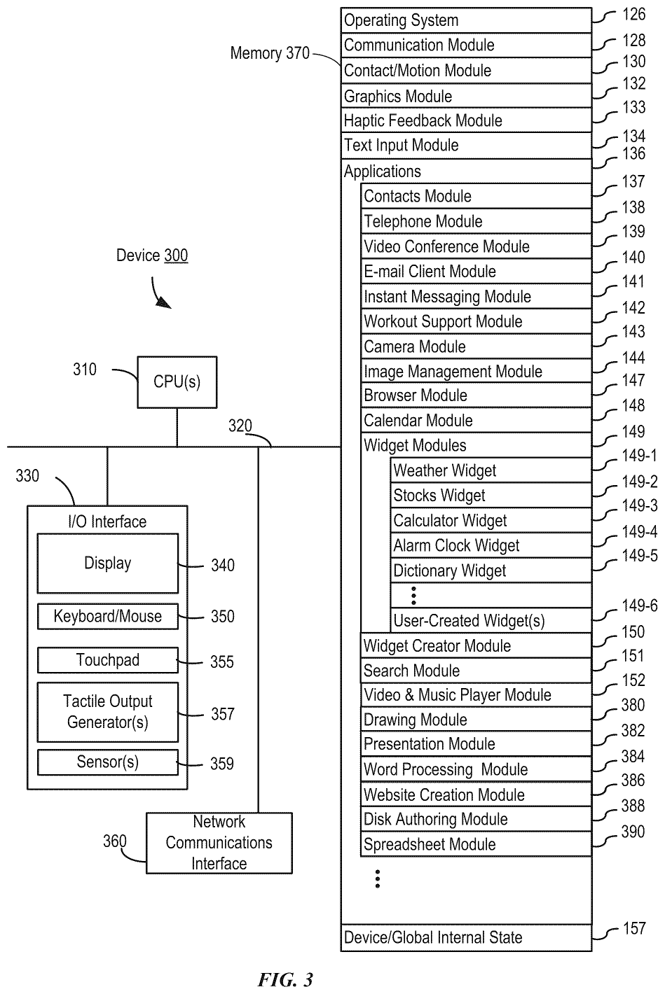

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

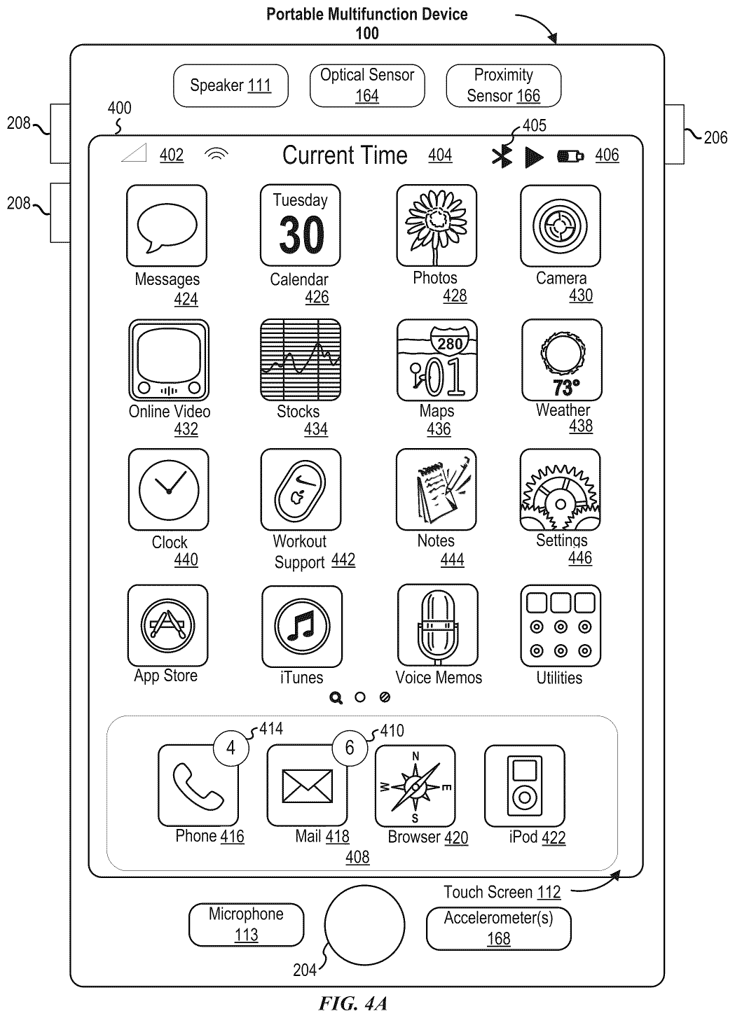

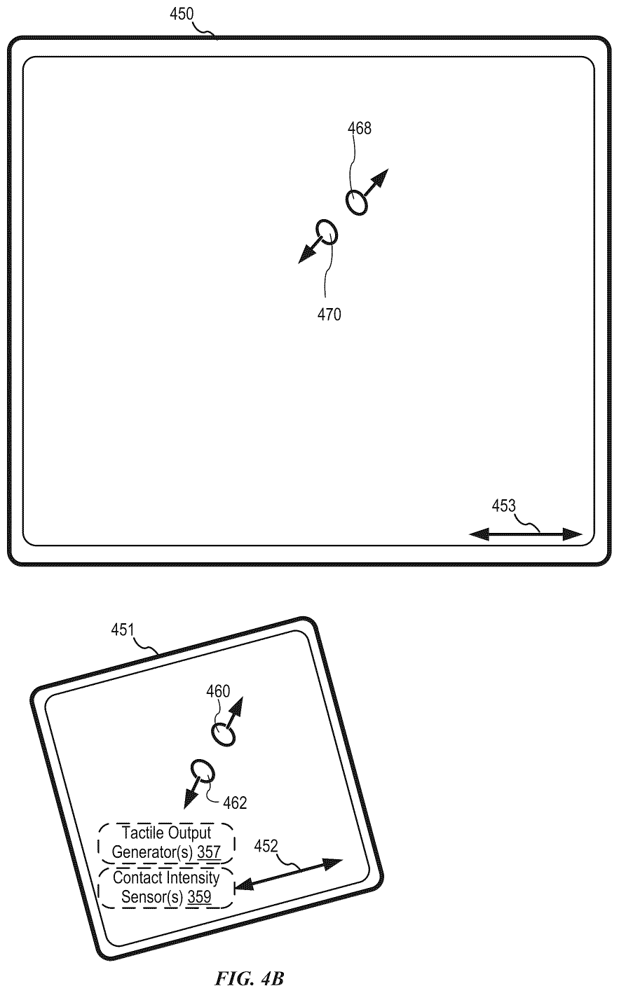

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

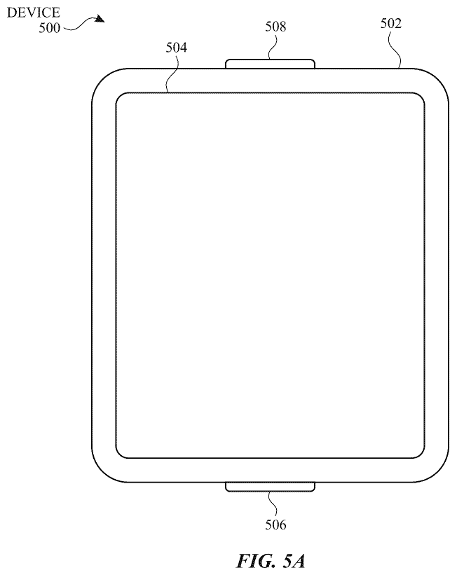

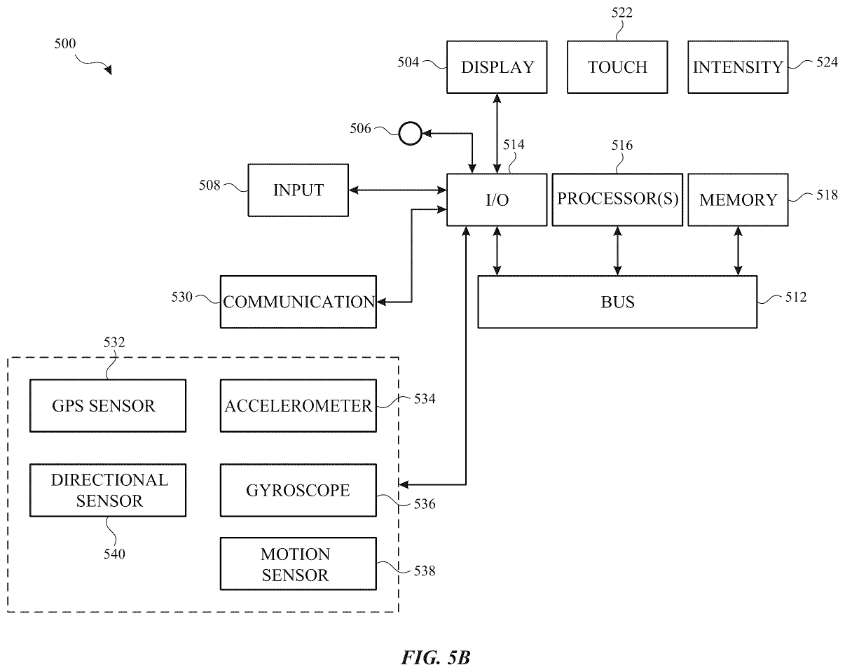

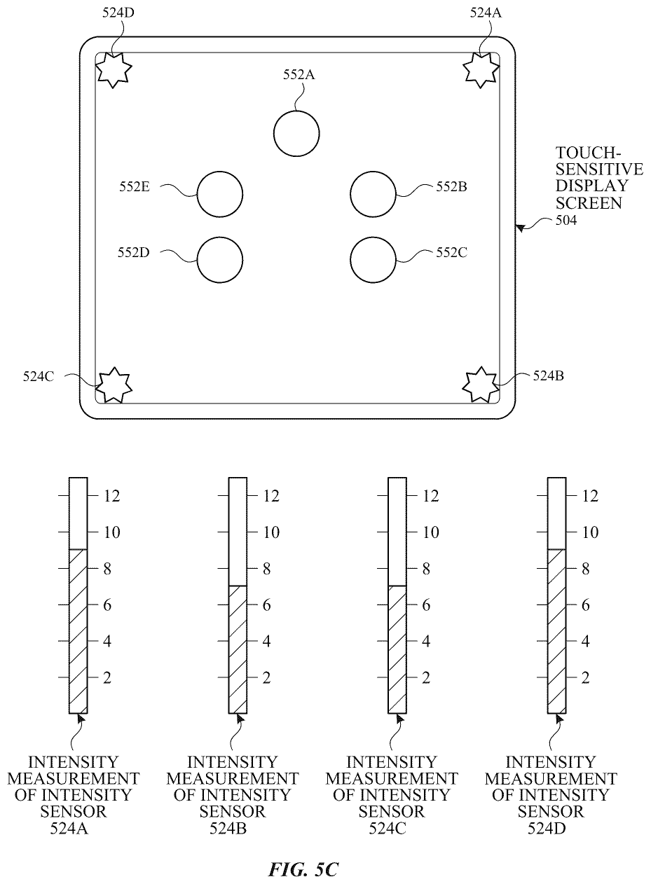

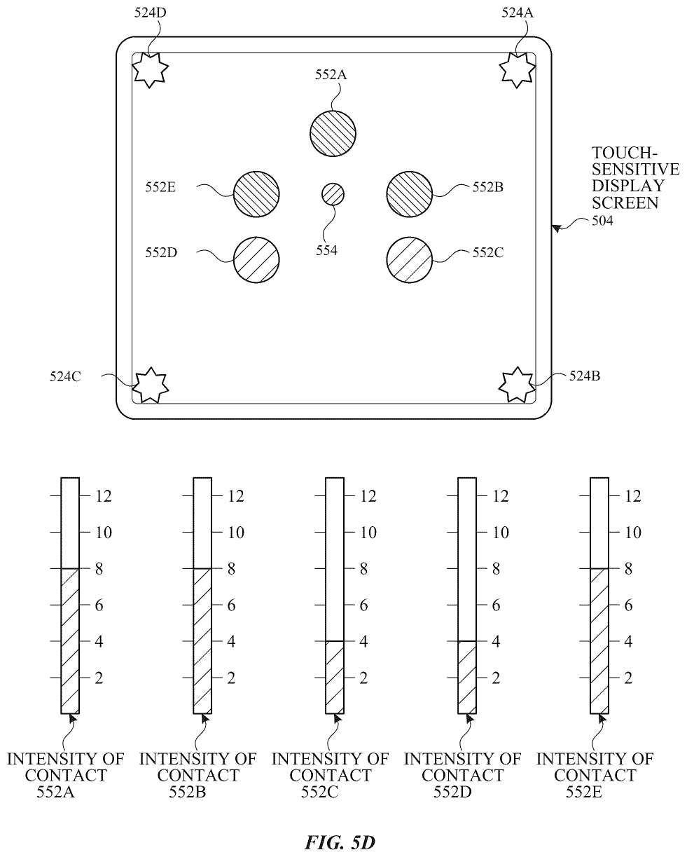

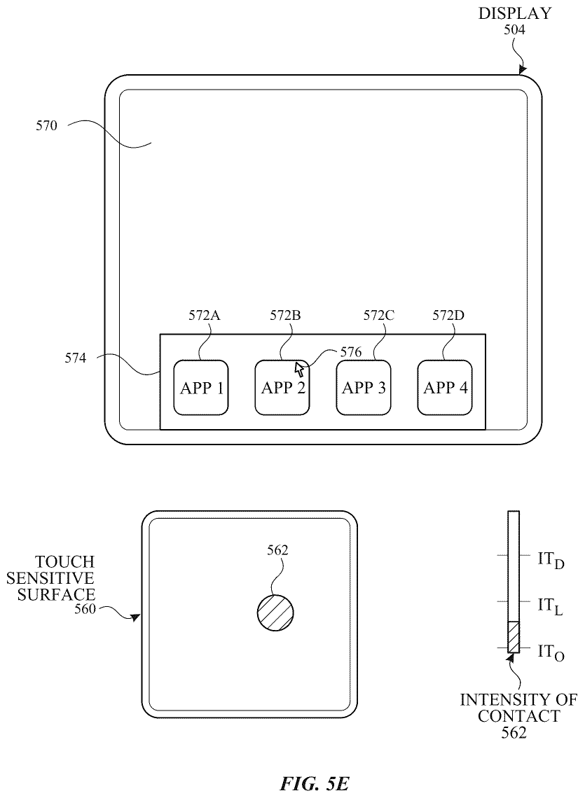

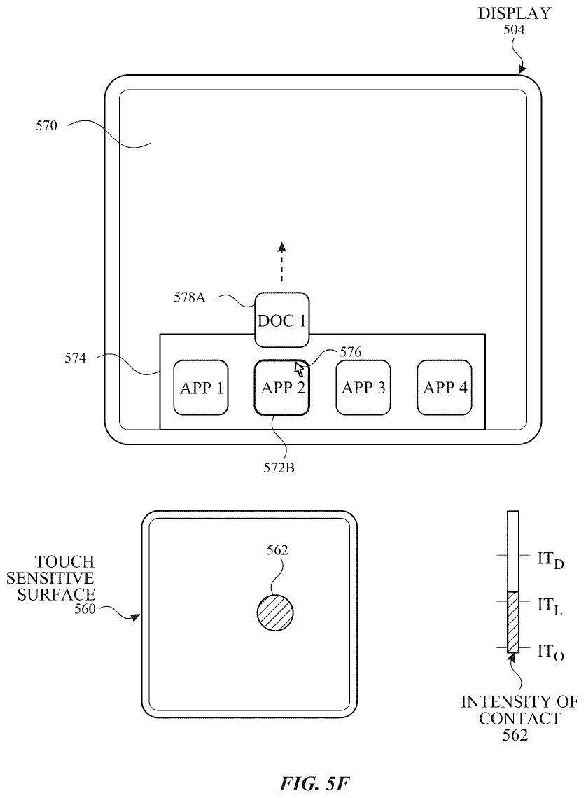

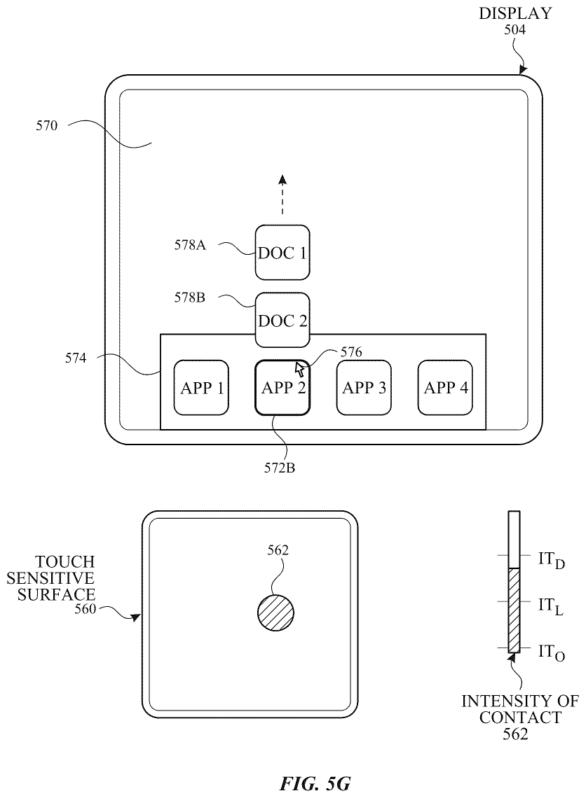

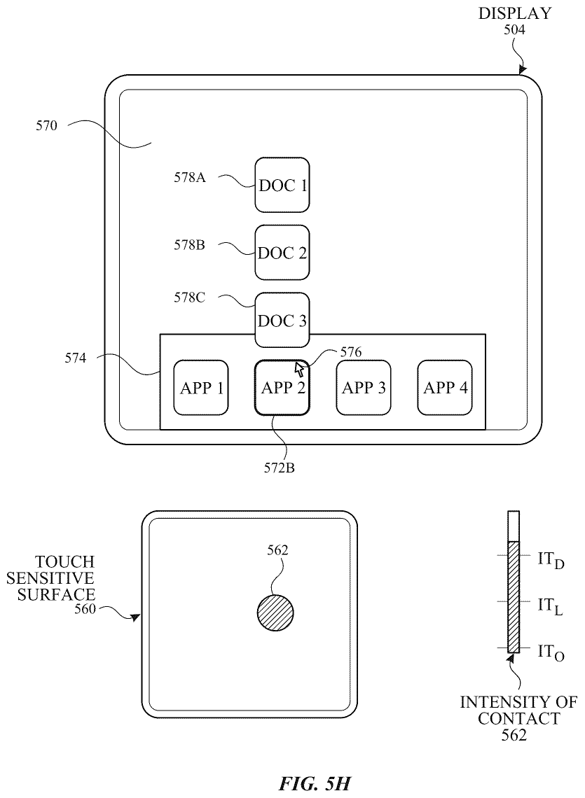

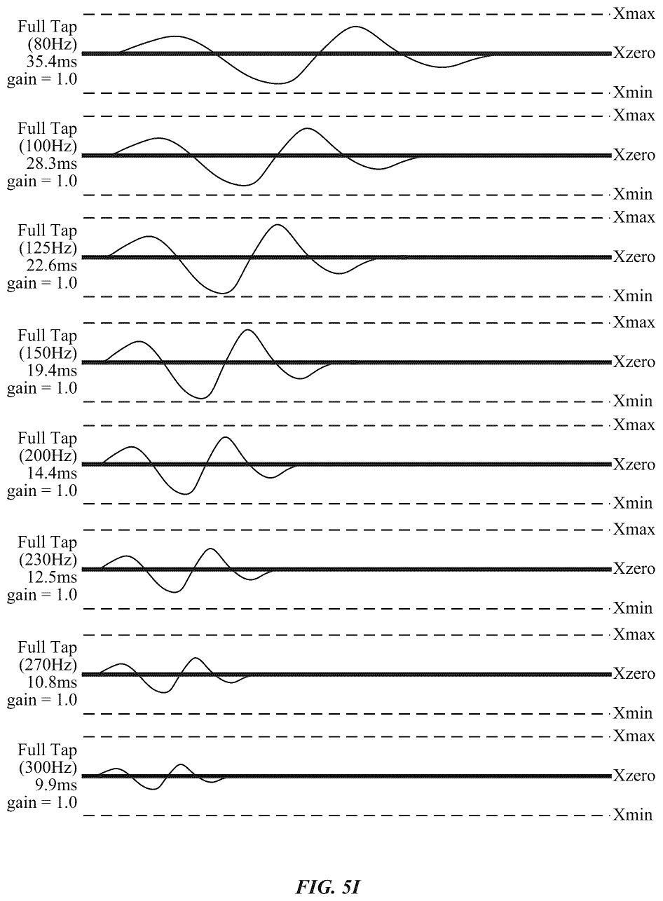

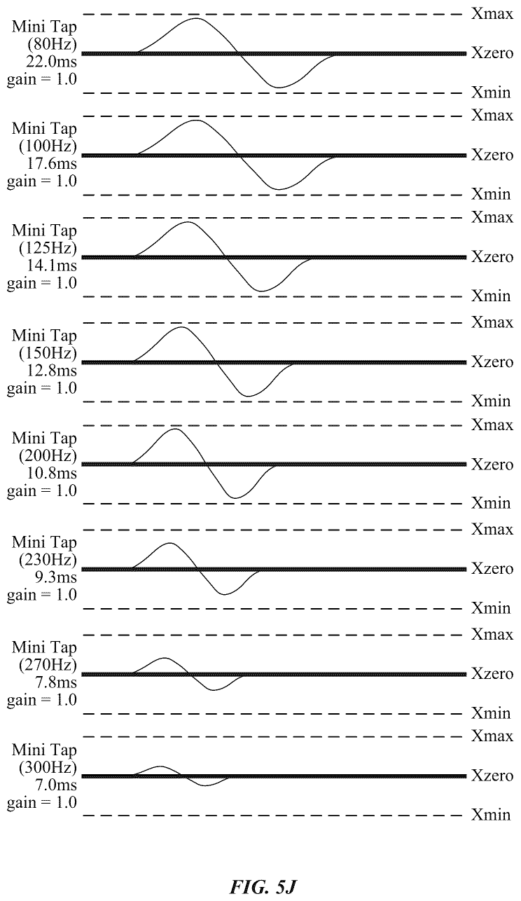

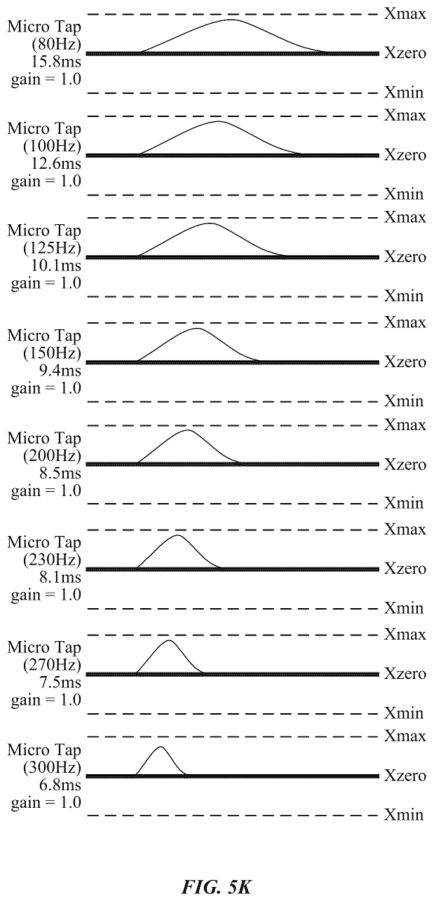

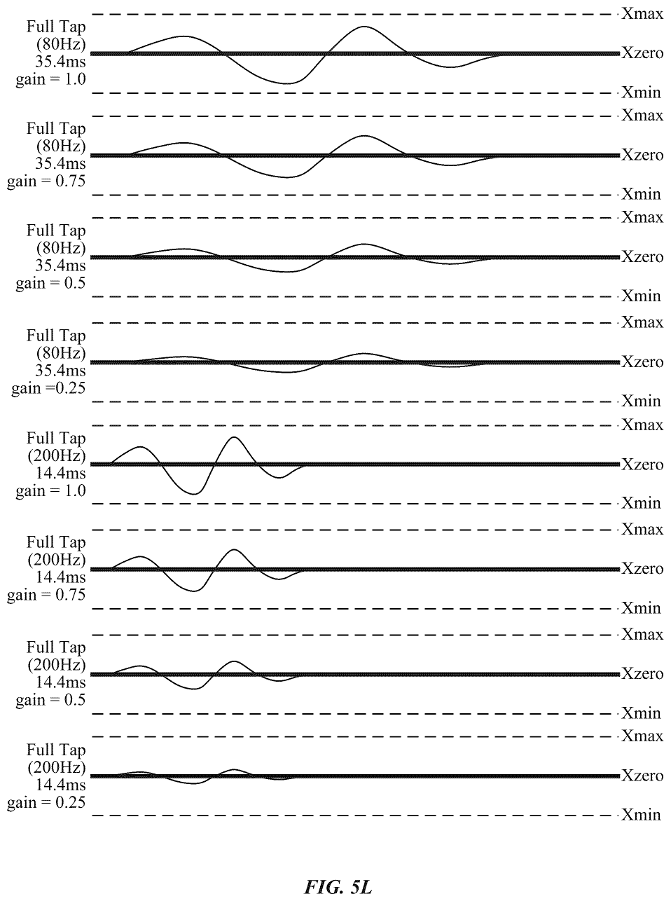

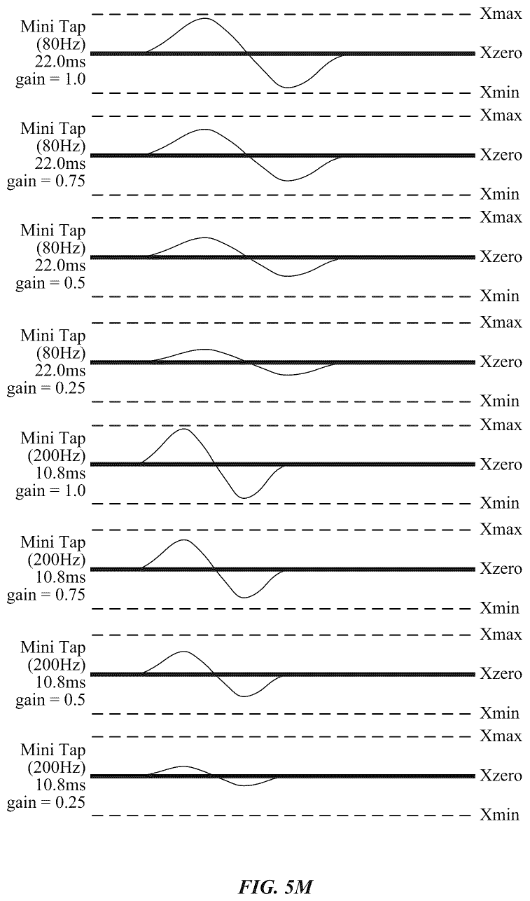

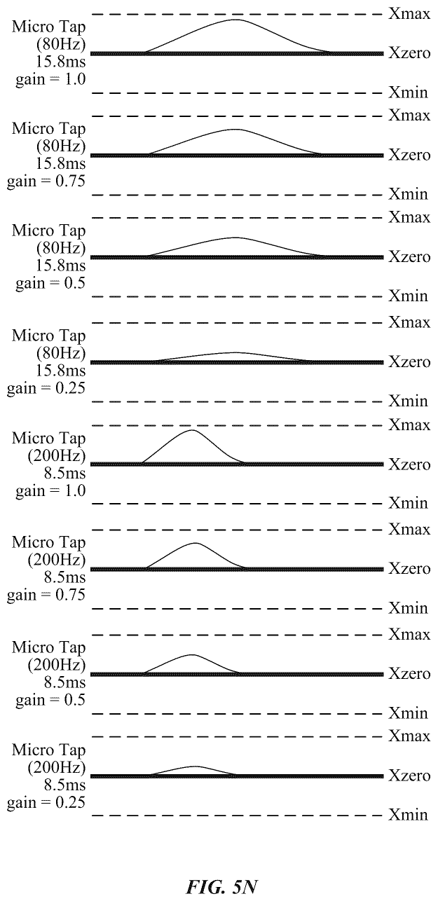

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

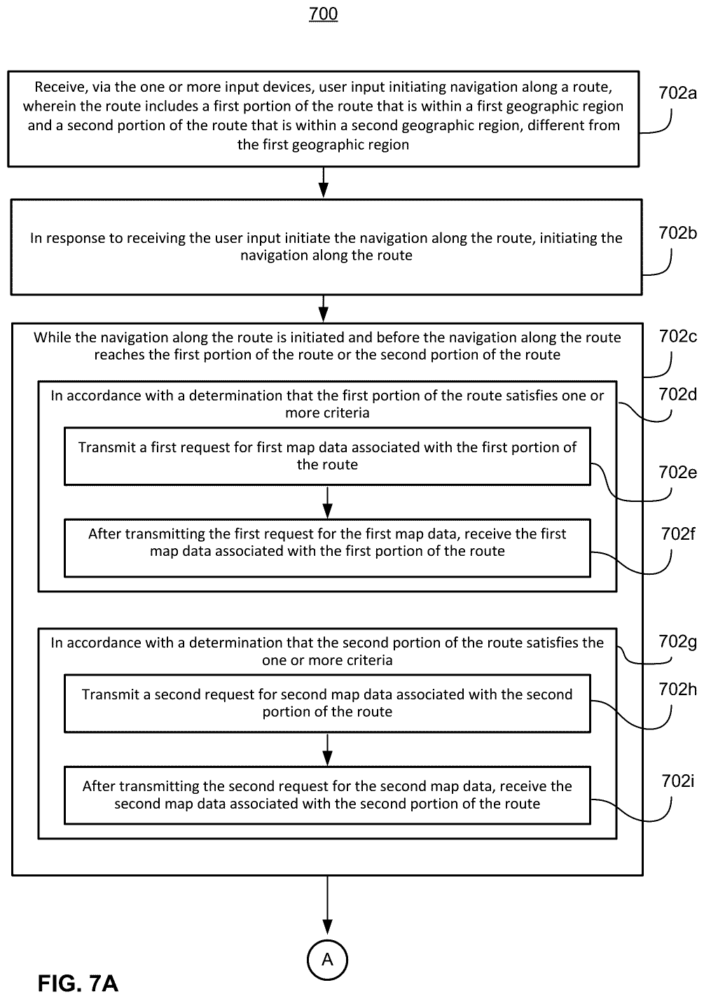

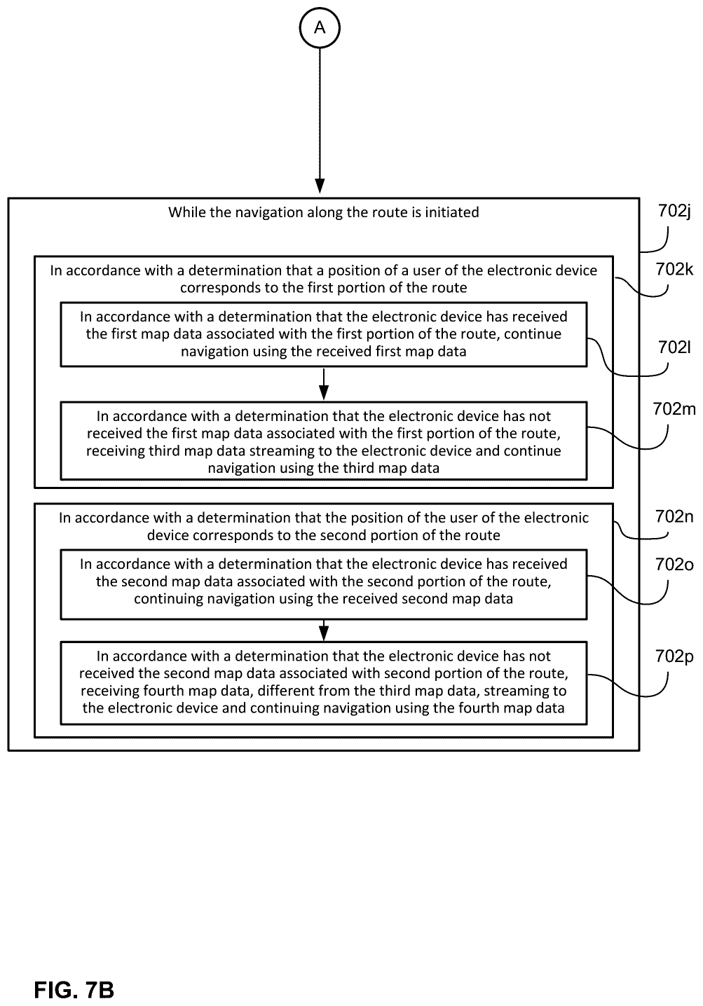

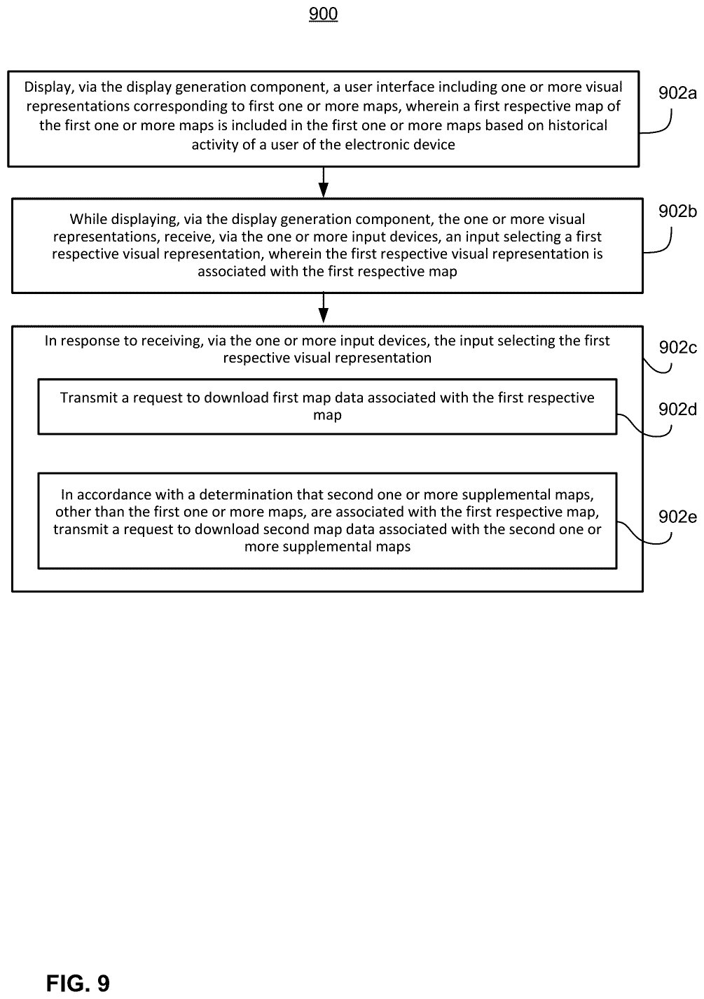

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7A-7B, 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and/Di is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT L”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT S”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

More specifically, FIGS. 5I-5K provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in these figures, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 5L-5N, which are each shown with variants having a gain of 1.0, 0.75, 0.5, and 0.25. As shown in FIGS. 5L-5N, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Nz, and 200 Hz).

FIGS. 5I-5N show tactile output patterns that have a particular waveform. The waveform of a tactile output pattern represents the pattern of physical displacements relative to a neutral position (e.g., Xzero) versus time that a moveable mass goes through to generate a tactile output with that tactile output pattern. For example, a first set of tactile output patterns shown in FIG. 5I (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 5J (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 5K (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 5I-5N include Xmin and Xmax values which represent the maximum and minimum extent of movement of the moveable mass. For larger electronic devices with larger moveable masses, there may be larger or smaller minimum and maximum extents of movement of the mass. The examples shown in FIGS. 5I-5N describe movement of a mass in one dimension, however similar principles would also apply to movement of a moveable mass in two or three dimensions.

As shown in FIGS. 5I-5K, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 5I-5N, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. SI). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 5I-5K, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metric s (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 5I-5K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well. Table 1 below provides representative examples of tactile output/haptic feedback behaviors and configurations, and examples of their use with respect to the user interfaces for managing content-based tactile outputs that are illustrated and described herein.

TABLE 1

| | | Textural |
|---|---|---|
| Type of Tactile | | (continuous) or |
| Output Sequence | Waveform | Discrete |
| “Major” | MiniTap at 180 Hz | Discrete |
| “Minor” | MicroTap at 80 Hz | Textural |
| “Major-reduced” | MiniTap at 200 Hz | Discrete |
| “Minor-Reduced” | MicroTap at 200 Hz | Discrete |

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Proactive Map Data Retrieval

Users interact with electronic devices in many different manners. The embodiments described below provide ways in which an electronic device proactively obtains map data associated with one or more portions of a route. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

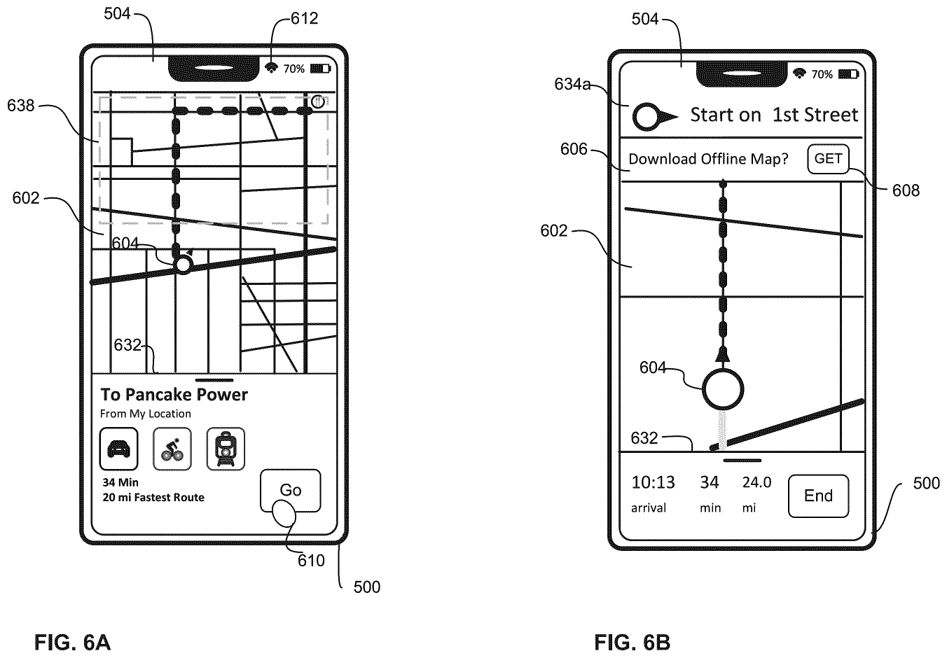

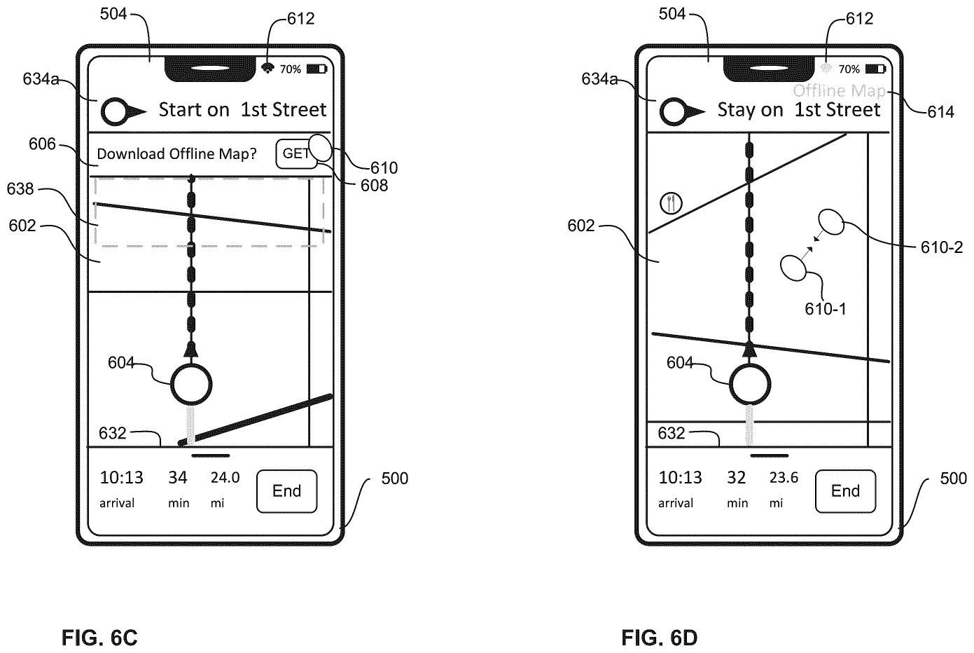

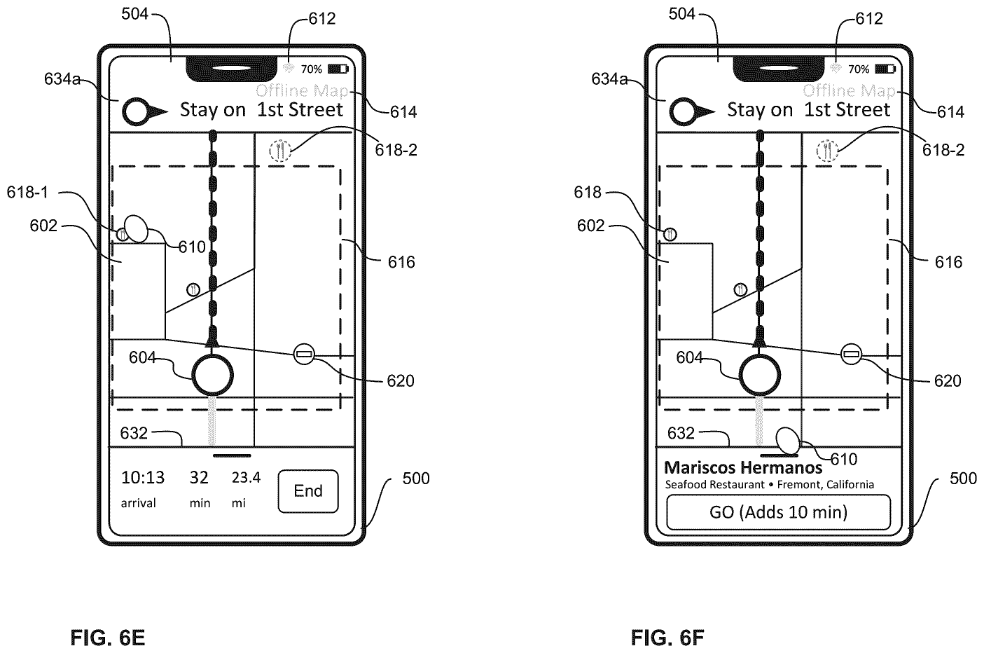

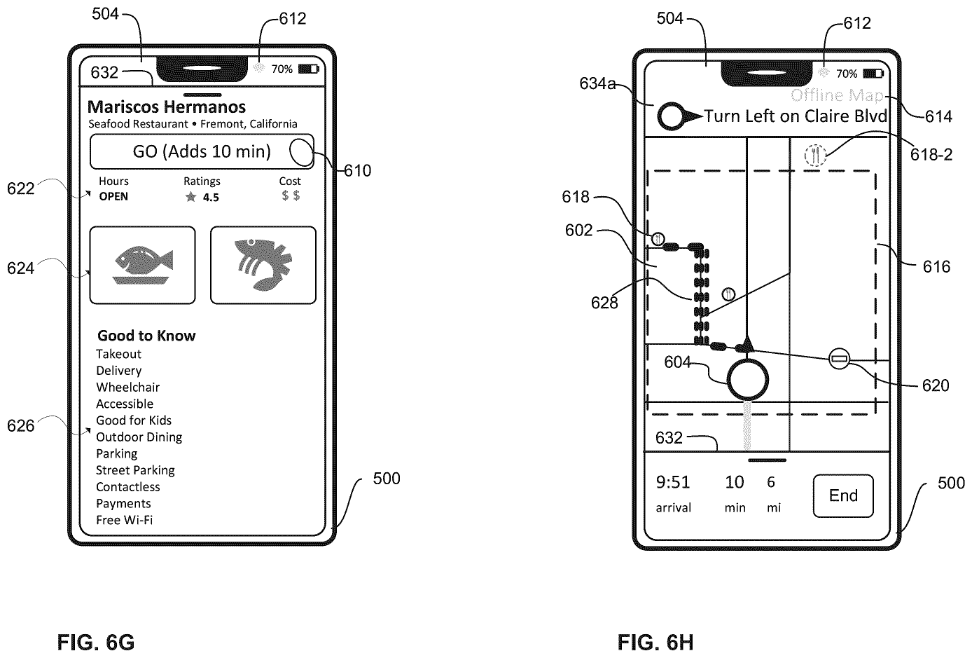

FIGS. 6A-6H illustrate exemplary ways in which an electronic device obtains and uses offline map data in accordance with some embodiments of the disclosure. The embodiments in these figures are used to illustrate the processes described below, including the processes described with reference to FIGS. 7A-7B. Although FIGS. 6A-6H illustrate various examples of ways an electronic device is able to perform the processes described below with reference to FIGS. 7A-7B, it should be understood that these examples are not meant to be limiting, and the electronic device is able to perform one or more processes described below with reference to FIGS. 7A-7B in ways not expressly described with reference to FIGS. 6A-6H.

In some embodiments, electronic device 500 is configured to provide navigation including one or more directions and visual indication(s) of the user's current position, direction, and movement displayed on a map. In some embodiments, the one or more directions are included in a route to destination. In some embodiments the route includes one or more portions corresponding to one or more geographic regions. In some embodiments, a respective portion of the route has insufficient and/or marginal wireless coverage such that user experience is degraded. As such, in some embodiments, electronic device 500 proactively obtains map data to provide a feature rich experience to continue navigation and view information about points of interest along the route while the user is within the respective portion of the route having insufficient and/or marginal wireless coverage.

FIG. 6A illustrates an electronic device 500 including a display 504 that is currently displaying a preview of a navigational route. The preview includes an indication 604 of a current location of a user of the electronic device 500. Indication 612 indicates that a communication network, such as a cellular data network and/or global positioning network is of sufficient quality such that the user optionally receives data in near time, or nearly in real time. Region 638 overlaid over map 602 illustrates an area within which the communication network optionally is lacking and/or insufficient. As referred to herein, an insufficiency and/or marginality of coverage of a network is understood to include one or more regions of a user's environment within which signal strength, quality, data speed, data latency, and/or any other factors associated with a network (e.g., a wireless network) of the electronic device 500 are such that the electronic device is unable to obtain data (e.g., map data) and/or is unable to obtain sufficient data to perform one or more operations, such as to display metadata associated with a point of interest within a map and/or determine an alternative navigational route toward a destination while within the one or more regions. Electronic device 500 optionally detects contact 610 on the “Go”′ button to initiate the navigation directions, which optionally corresponds to detecting a touch on a touch-sensitive surface (e.g., a touch screen) of device, such as display 504.

In FIG. 6B, in response to contact 610 initiating navigation, electronic device 500 initiates the navigation along the route. For example, banner 632 optionally is updated to reflect an estimated time of arrival, drive time, and remaining distance to drive. Additionally, banner 606 optionally is displayed, including a selectable option 608 to obtain map data (e.g., first map data and/or second map data corresponding to a first and/or a section portion of the route, respectively) associated with the route. In some embodiments, electronic device 500 forgoes display of banner 606 and/or selectable option 608, and downloads the map data without detecting an express input, such as selection of selectable option 608, to download such map data. Automatically downloading the map data is advantageous at least because in response to navigating along the route, electronic device 500 optionally obtains the map data without requiring additional input to do so, and/or reduces the likelihood that a user of the electronic device 500 has a sub-optimal experience while interacting with electronic device 500. For example, electronic device 500 optionally downloads map data corresponding to region 638 within which electronic device 500 optionally would encounter a high latency and/or slow data connection, as described in further detail below. While a location of the electronic device corresponds to region 638 (e.g., while within region 638), the electronic device 500 optionally detects a query (e.g., a voice input, an input via a touch screen, and/or using other sensing modalities) to search for restaurants, and optionally uses the previously downloaded map data to optionally compile and display representations of such restaurants in accordance with the query. Were it not for the previously obtained map data, due the insufficient network coverage, electronic device 500 optionally would experience slow and/or delayed delivery of map data required to display the results of the query. Thus, in some embodiments, electronic device 500 obtains “offline” map data such that the quality of user experience with the mapping application included in the electronic device is maintained, independent of a communication network.

In FIG. 6B, indication 604 of user position along the route continues along the route while the electronic device 500 maintains a connection to a wireless communication network. A first direction included in the route is displayed in banner 634a (e.g., “start on Pt Street”).

In FIG. 6C, the electronic device 500 detects contact 610 directed to selectable option 608 to download the map data corresponding to one or more portions of the route. As shown by the progress of indication 604, the electronic device 500 optionally has advanced along its route, approaching region 638 corresponding to an area of insufficient communication network coverage.

In FIG. 6D, the electronic device 500 advances into the region 638 such that indication 612 indicates that the user's connection to a communication network (e.g., a wireless data network) is insufficient. The electronic device 500 optionally displays a visual indication 614 (e.g., “Offline Map”) indicating to the user that the previously obtained map data is currently being used. The electronic device 500 optionally detects contact 610-1 and contact 610-2, optionally corresponding to a pinching touch gesture on display 504, and initiates a process to modify a displayed area of map 602 (e.g., to zoom the map outwards).

In FIG. 6E, the electronic device 500 scales map 602 such that further details are displayed via display 504. For example, the electronic device 500 optionally uses the previously downloaded map data to display one or more visual representations of points of interest within an area corresponding to region 616. In some embodiments, region 616 corresponds to a portion of the map and/or of the route within which the electronic device has downloaded map data. For example, visual indication 618-1 optionally corresponds to a representation of a restaurant that is displayed, and associated with respective information, that was included in the previously downloaded map data. In some embodiments, if the electronic device 500 has not obtained the first map data, the electronic device forgoes display of indication 618-1 and/or indication 620. Indication 620 is described in further detail below.

In some embodiments, as described in further detail with reference to method 700 and in further detail below, the electronic device 500 obtains respective map data corresponding to indication 618-1, despite a location of 618-1 not being along the route. For example, because indication 618-1 is within a threshold distance of the route, the electronic device 500 proactively further obtains offline map data (e.g., included in the first map data) to display indication 618-1.

In some embodiments, the first map data includes traffic information. For example, indication 620 optionally corresponds to a warned road closure. In some embodiments, the map data includes indications of statuses associated with one or more roads, such as temporary weather related conditions of the road, closures due to construction, road debris, and/or other information concerning availability and/or quality of one or more roads. In some embodiments, while within the region 616 (e.g., while the electronic device 500 is offline), the electronic device detects an input requesting navigation toward a destination within and/or outside of the region 616. In some embodiments, using the traffic information, the electronic device 500 displays a proposed route (e.g., similar to as shown in FIG. 6A) using the traffic information included in the first map data to avoid a road closure, such as indicated by indication 620. In some embodiments, the electronic device routes to a border of the region 616 to guide the user toward an area where the user of the electronic device 500 expects an improved signal quality with respect to its communication network.

In some embodiments, the electronic device 500 obtains map data within a threshold distance of a current position of the electronic device 500 while navigating along a route and/or within a threshold distance of the route before device 500 actually reaches that portion of the route. In some embodiments, because the electronic device is not in proximity to indication 618-2 as shown in FIG. 6E and lacks a sufficient network connection to obtain additional map data, other that the previously obtained first map data, the electronic device 500 forgoes display of indication 618-2. In some embodiments, the electronic device 500 detects an input directed to indication 620, and in response to the input, displays respective information (e.g., transit related information) associated with indication 620. In FIG. 6E, the electronic device 500 detects an input indicated by contact 610 selecting indication 618-1, and initiates display of information associated with indication 618-1.

In FIG. 6F, the electronic device 500 optionally displays banner 632 with updated respective information associated with indication 618-1, where indication 618-1 is associated with a point of interest that is not directly along the route of the electronic device 500. In response to optionally detecting contact 610, corresponding to a selectable option to display a second, not yet displayed portion of the respective information, the electronic device displays the banner 632. In some embodiments, banner 632 includes respective information associated with a point of interest represented by indication 618-1. For example, a restaurant optionally corresponding to indication 618-1 (e.g., “Mariscos Hermanos”) has respective metadata and/or information associated with the point of point of interest. The information optionally includes operating hours in banner 622, contact information, ratings, approximate cost, one or more representations of media (e.g., pictures) associated with the point of interest, and/or other “good to know” information 626, described in further detail with reference to method 700 and below. As indicated by indicator 612, the electronic device 500 optionally is “offline,” and thus uses the previously obtained first map data to display the respective information included in banner 632. In some embodiments, the respective information is the same, or nearly the same as would be obtained if the electronic device 500 was in an area of sufficient network coverage, and optionally streams map data to obtain and display the respective information.

In some embodiments, the electronic device detects an input such as contact 610 directed to a selectable option to navigate toward indication 618-1, and using the previously obtained map data, inserts navigation toward indication 618-1 into a queue of directions. In some embodiments, the electronic device 500 uses the first map data to generate one or more directions to navigate from indication 618-1 back toward an original destination along the route (e.g., before contact 610 is detected). In some embodiments, the electronic device 500 selects indication 618-1 as a terminal destination of navigation, rather than insert directions toward indication 618-1 into a queue of directions.

In FIG. 6H, in response to initiating navigation toward indication 618-1, the electronic device updates banner 632 to reflect the estimated arrival time, distance, and travel time to indication 618-1. Further, banner 634a optionally is displayed with a new, first direction toward indication 618-1. In some embodiments, the estimated arrival time, distance, travel time, and first direction are all determined using the first map data, due to the offline status of the electronic device 500. In some embodiments, the estimated arrival time is based at least in part on historical traffic data associated with a respective portion of the route. For example, portion 628 of the route is determined based on historical “snapshots” of traffic data that is captured at points in time across a day. The first map data optionally includes such historical traffic data, such that the electronic device optionally determines an estimated amount of traffic, based on a history of traffic along portion 628 of the route, and accordingly adjusts an estimated arrival time in accordance with the history of traffic.

FIGS. 7A-7B is a flow diagram illustrating a method 700 of exemplary ways of proactively obtaining and using offline map data to navigate along a route in accordance with some embodiments, such as in FIGS. 6A-6H. The method 700 is optionally performed at an electronic device such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways to proactively obtain map data for offline use. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device in communication with one or more input devices and a display generation component. (e.g., a mobile device (e.g., a tablet, a smartphone, and/or a media player), a computer (e.g., a desktop computer and/or a laptop computer), or a wearable device (e.g., a watch and/or a head-mounted device). In some embodiments, the display generation component is a display integrated with the electronic device (optionally a touch screen display) and/or an external display such as a monitor, projector, and/or television or a hardware component (optionally integrated or external) for projecting a user interface or causing a user interface to be visible to one or more users. In some embodiments, method 700 is performed at or by an automobile (e.g., at an infotainment system of an automobile having or in communication with one or more display generation components and/or input devices).

In some embodiments, the electronic device receives (702a), via the one or more input devices, user input initiating navigation along a route, such as contact 610 as shown in FIG. 6A, wherein the route includes a first portion of the route that is within a first geographic region and a second portion of the route that is within a second geographic region, different from the first geographic region, such as portions of the route as shown in FIG. 6A. In some embodiments, the electronic device has access to a maps application that enables the electronic device to display maps of physical locations and navigation directions between locations. The user optionally specifies a start and end location when requesting navigation directions along a route. In some embodiments, the electronic device uses a location sensor (e.g., GPS or other positioning sensor) to identify a current location of the electronic device, thus enabling the user to request directions (e.g., a route) from the current location of the electronic device to a second location. In some embodiments, the user provides the sequence of inputs using a user interface of the maps application. In some embodiments, the user provides the sequence of inputs using a system user interface of the electronic device (e.g., voice assistant and/or system-wide search). In some embodiments, the sequence of the one or more inputs is received before beginning to navigate along a route from a first physical location (e.g., starting location for the route) to a second physical location (e.g., ending location for the route) or during navigation. In some embodiments, a first portion of the route corresponds to first one or more directions and a first geographic region. For example, the route optionally directs a user of the electronic device to traverse a first segment of a roadway that optionally corresponds to (e.g., is included within) a first geographic area including the first segment of the roadway. In some embodiments, the first geographic area includes additional one or more roadways, paths, geographic features such as rivers, and/or points of interest (POI) such as landmarks and/or restaurants. In some embodiments, the second portion of the route has one or more characteristics analogous to the first portion of the route. In some embodiments, the second portion of the route is different from the first portion of the route. For example, the first portion of the route corresponds to a first geographic area including the first portion of the previously described roadway and the second portion of the route optionally includes a second geographic area including a second, different portion, of the previously described roadway (or a different roadway).

In some embodiments, in response to receiving the user input initiating the navigation along the route, such as contact 610 in FIG. 6A, the electronic device initiates the navigation along the route (702b) and while the navigation along the route is initiated and before the navigation along the route reaches the first portion of the route or the second portion of the route, such by indication 604 as shown in FIG. 6C (702c), in accordance with a determination that the first portion of the route satisfies one or more criteria (702d) the electronic device transmits (702e) a first request for first map data associated with the first portion of the route, such as a request for data as shown in FIG. 6C. For example, the electronic device optionally displays a visual representation of a first direction of one or more directions included within the route, such as a textual and/or graphical representation of the first direction (e.g., the upcoming direction) and optionally initiates a more granular tracking of the location of the electronic device. For example, while the navigation along the route is initiated, the electronic device optionally displays a map via the display generation component, an indication of a current location of the electronic device on the map, a route line overlaid on the map that indicates on or more portions of the route and/or navigation directions for the route (e.g., the upcoming navigation direction and/or future navigation directions).

For example, optionally in response to the user input initiating navigation and/or while navigation has commenced, and in some embodiments, optionally not in response to the user input initiating navigation. In some embodiments, the below-described steps occur before the position of the electronic device corresponds to a position that would require map data for the first portion of the route and/or the second portion of the route. For example, the electronic device optionally obtains respective map data corresponding to the first portion of the route including location data describing one or more locations corresponding to (e.g., included within) the first portion of the route, wherein the respective map data optionally is obtained (e.g., downloaded for offline or local use) while the user is at a second position along the route, not corresponding (e.g., not included within) the first portion of the route.

In some embodiments, the electronic device determines a respective portion of the route meets the one or more criteria, and initiates performance of one or more operations in response to the determination. For example, the one or more criteria include a criterion that is satisfied when a current location of the user during navigation optionally is proximate to a first geographic area including the first portion of the route. In some embodiments, the one or more criteria include a criterion that is satisfied when first portion of the route is included in the route (e.g., by default). In some embodiments, the one or more criteria include a criterion that is satisfied based on the first portion of the route satisfying one or more networking criteria, such as a lack of wireless network coverage and/or a relatively high degree of latency of the network (e.g., global positioning and/or cellular networks) along the first portion of the route. In some embodiments, the one or more criteria include a criterion that is satisfied based on a geographic area corresponding to the first portion of the route having insufficient and/or at least partially lacking network coverage (e.g., GSM, UMTS, CDMA, LTE, 5G and/or 5GNR). For example, optionally prior to, optionally in response to, and/or optionally shortly after the initiation of navigation, the electronic device optionally determines and/or receives an indication that the first portion of the route has insufficient network coverage (e.g., to obtain location and/or map data), and as such initiates a process to download (e.g., transmits a request to download) map data corresponding to the geographic area.

For example, the electronic device optionally communicates with one or more second electronic devices (e.g., servers) to request map data corresponding to the first portion of the route. In some embodiments, one or more requests are made for respective portions of the map data. In some embodiments, the first map data includes navigational data such as Topologically Integrated Geographic Encoding and Referencing (TIGER) data, historical traffic data, positional data of points of interest, metadata describing the points of interest, topographical data, and/or other suitable types of data useful to inform the user of the contents and display representations of the first geographic area. For example, the electronic device optionally requests respective data that optionally is used to display a representation of a corresponding point of interest such as a silhouette or graphical icon representative of a restaurant along the route. Additionally or alternatively, the electronic device optionally detects a selection input (e.g., a gaze of the user, a contact on a touch-sensitive surface in communication with the electronic device, and/or actuation of a physical or virtual button) of the representation of the point of interest, and in response to the selection, displays metadata (e.g., address, photos, user reviews, contact information, encyclopedic information, and/or a list of related respective points of interest) associated with the point of interest. In some embodiments, the first map data includes respective data to display representations of the road and/or geographic features along the route. Thus, in some embodiments, first map data associated with the first portion of the route that otherwise would be obtained in real-time and/or near real-time via a communication network (e.g., a data network)—such as when the electronic device reaches a particular portion of the route that triggers download of map data for the first portion of the route—optionally is obtained (e.g., downloaded) in response to satisfaction of the one or more criteria described herein, optionally instead of in response to requesting such data (e.g., searching for such data and/or streaming such data) in response to a determined progress along the route. Thus, in some embodiments, the download of the first map data initiates because the one or more criteria are satisfied, and not in response to a determined progress along the route. In some embodiments, the map data has one or more characteristics of map data described with respect to method 900.

In some embodiments, after transmitting the first request for the first map data, the electronic device receives (7020 the first map data associated with the first portion of the route, such as a portion of the route shown in FIG. 6E. In some embodiments, the one or more second electronic devices receive the request for the first map data, and in response to the request, transmits at least a portion of the first map data. In some embodiments, different portions of the first map data are transmitted from a plurality of different devices to the electronic device. Therefore, the electronic device optionally stores the first map data before it would have otherwise requested and/or downloaded the first map data based on and/or during progress along the navigation route.

In some embodiments, in accordance with a determination that the second portion of the route satisfies the one or more criteria (702g), the electronic device transmits (702h) a second request for second map data associated with the second portion of the route, such as a request for data as shown in FIG. 6C in response to contact 610. In some embodiments, the transmission of the second request in accordance with a determination the second portion of the route satisfies the one or more criteria occurs concurrently, or as part of the same request as the first request for the first map data. In some embodiments, the second map data has one or more characteristics analogous to the first map data, but with respect to the second portion of the route rather than the first portion of the route.

In some embodiments, after transmitting the second request for the second map data, the electronic device receives (702i) the second map data associated with the second portion of the route, such as map data to display the user interface as shown in FIG. 6E. In some embodiments, the receiving of the second map data is concurrent with or is a part of the same receiving of the first map data as described with respect to the receiving of the first map data. In some embodiments, transmitting the second request and/or the receiving of the second map data has one or more of the characteristics of the transmitting of the first request and/or the receiving of the first map data.

In some embodiments, while the navigation along the route is initiated (702j), in accordance with a determination that a position of a user of the electronic device corresponds to the first portion of the route (702k), such as a position as shown in FIG. 6E, in accordance with a determination that the electronic device has received the first map data associated with the first portion of the route (e.g., because the first portion of the route satisfied the one or more criteria), the electronic device continues (7021) navigation using the received first map data, such as navigation as shown in FIG. 6E (e.g., without using the received third map data, described below). For example, the electronic device optionally determines that a current position of the user and/or electronic device is within a threshold distance (e.g., 0.01, 0.1, 0.25, 0.5, 1, 2.5, 5, or 10 miles) of the first portion of the route, such as a boundary of the geographic region or a center of the geographic region.

For example, the electronic device optionally uses the previously received first map data to provide navigation guiding the user—as described with respect to the first map data previously—and/or to monitor the movement of the electronic device relative to the first portion of the route. In some embodiments, the first map data is used to determine and/or predict a position and/or a velocity of the electronic device along and/or with respect to the route. For example, a network connection to one or more network sources (e.g., a GPS satellite and/or a cellular tower) optionally is determined to be high latency and/or lacking sufficient coverage, and the electronic device optionally uses the first map data to determine the updated position(s) of the electronic device in and/or during the first portion of the route. In some embodiments, the electronic device forgoes one or more operations to communicate data, such as requesting and/or receiving the first map data. For example, upon approaching and/or entering the first portion of the route, the electronic device optionally renders a representation of a building and/or displays metadata associated with the building using previously downloaded first map data that otherwise would need to be requested and/or received from another device (e.g., a network source and/or a server) in real-time, or nearly real-time.

In some embodiments, in accordance with a determination that the electronic device has not received the first map data associated with the first portion of the route (e.g., because the first portion of the route did not satisfy the one or more criteria), the electronic device receives (702m) third map data streaming to the electronic device and continuing navigation using the third map data, such as navigation as shown in FIG. 6E using streamed data. For example, the electronic device optionally determines that the first map data was not received prior to approaching and/or entering the first geographic region, and optionally determines a position and/or velocity of the electronic device based on the third map data that optionally is received in real-time, or nearly real-time. In some embodiments, the electronic device forgoes the request and/or receipt of the first map data. In some embodiments, the first map data and/or the third map data (e.g., roadway data and/or point of interest data) are the same or similar, but the first map data is downloaded at a first time and the third map data is streamed at a second time, different from the first time.

In some embodiments, in accordance with a determination that the position of the user of the electronic device corresponds to the second portion of the route (702n), such as described herein (e.g., similar to or the same as described with respect to the determination of correspondence of user position with the first portion of the route), in accordance with a determination that the electronic device has received the second map data associated with the second portion of the route (e.g., because the second portion of the route satisfied the one or more criteria), the electronic device continues (702o) navigation using the received second map data (e.g., similar to or the same as described with respect to the determination of receipt of the second map data and/or similar to or the same as described with respect to the continuing of navigation using the first map data).

In some embodiments, in accordance with a determination that the electronic device has not received the second map data associated with second portion of the route (e.g., because the second portion of the route did not satisfy the one or more criteria), the electronic device receives (702p) fourth map data, different from the third map data, streaming to the electronic device and continuing navigation using the fourth map data (e.g., similar to or the same as described relative to the streaming of the third map data). Using previously obtained (e.g., first, second) map data or streamed (e.g., third, fourth) map data to continue navigation while a user position corresponds to a respective portion of a route ensures that navigation along a route can continue seamlessly, regardless of network quality along the route.

In some embodiments, the one or more criteria include a criterion that is satisfied in accordance with a determination that the location of the electronic device is within a threshold distance (e.g., 0.01, 0.05, 0.1, 0.5, 1, 5, 10 15, 20, 25, 50, 100, 250, 500, 1000, or 10000 m) of the first portion of the route, such as the distance shown by region 616 in FIG. 6E. For example, the electronic device optionally detects that the location of the electronic device is within the threshold distance of a border surrounding the first portion of the route and/or of a respective point along the first portion of the route.

In some embodiments, in accordance with the determination that the first portion of the route satisfies the one or more criteria, the electronic device displays, via the display generation component, a selectable option that is selectable to transmit the first request for the first map data associated with the first portion of the route, receives, via the one or more input devices, a first input, other than the user input, selecting the selectable option, in response to receiving, via the one or more input devices, the electronic device performs the transmitting of the first request for the first map data associated with the first portion of the route, such as in response to contact 610 as shown in FIG. 6C (For example, the selectable option optionally is a virtual button optionally including text (e.g., “get,” “download,” or “DL”).

For example, the first input optionally is a contacting of a surface (e.g., a touch sensitive surface) at the location of the displayed selectable option, a voice input designating the selection, detection of an air pinching gesture contacting a thumb and an index finger while the attention of the user is directed to the selection option, and/or a detection of attention of the user (e.g., gaze) directed to the selection option for a period of time greater than a threshold period of time (e.g., 0.01, 0.05, 0.1, 0.5, 1, 5, 10, 15, 25, 50, 100, 500, or 1000 s).

In some embodiment, in accordance with a determination that the electronic device is past the threshold distance of a respective point of the first portion of the route, the electronic device ceases display of the selectable option. Thus, the electronic device does not display a selectable option that is selectable to communicate a request for the first map data until the user has expressly provided input to initiate the request. Displaying a selectable option in accordance with a determination that the electronic device is proximate to the first portion of the route reduces the need to preemptively download the first map data, thereby reducing the processing and power consumption required if the user does not wish to download the first map data.

In some embodiments, while the navigation along the route is initiated, in accordance with the determination that the position of the user of the electronic device corresponds to the first portion of the route and in accordance with the determination that the electronic device has received the first map data associated with the first portion of the route, displaying, via the display generation component, a visual indication indicative of the use of the received first map data to continue the navigation, such as indication 614 as shown in FIG. 614. For example, while the electronic device optionally reaches and/or is traveling along the first portion of the route and in accordance with a determination that the electronic device has previously received the first map data, the electronic device optionally displays a graphical and/or textual indication indicating to the user that the first map data is in use. In some embodiments, the visual indication describes the quality of a communication network of the electronic device (e.g., including low strength and/or nonexistent network coverage within the first portion of the route). In some embodiments, the visual indication indicates that the electronic device is “offline,” and indicates that a displayed map is using the first map data (e.g., offline data) stored locally to the electronic device to continue the navigation. In some embodiments, in accordance with a determination that the position of the user corresponds to the first portion of the route and in accordance with a determination that the electronic device has not received the first map data associated with the first portion of the route, the electronic device forgoes displaying, via the display generation component, the visual indication indicative of the use of the received first map data to continue the navigation. Displaying a visual indication indicative of use of received map data communicates a state of the electronic device and reduces the need for user input attempting to obtain further map data, such as “refreshing” a maps application.

In some embodiments, the first map data includes data for one or more points of interest (POI) that satisfy one or more second criteria, including a criterion that is satisfied when the one or more POI are within a threshold distance (e.g., 0.01, 0.05, 0.1, 0.5, 1, 5, 10 15, 20, 25, 50, 100, 250, 500, 1000, 10000, or 100000 m) of the first portion of the route, such as a threshold corresponding to region 616 as shown in FIG. 6E. For example, the first map data optionally includes data described with respect to selection of a representation of a point of interest as described herein. In some embodiments, the point of interest corresponds to one or more facilities, buildings, and/or businesses that are within a region surrounding the first portion of the route. For example, the electronic device optionally detects that a rest stop is within the threshold distance of a highway that the electronic device will travel along (e.g., defined by the route), and proactively requests data to route toward, provide descriptive information of, and/or display representation(s) of the rest stop. As another example, the electronic device optionally detects a restaurant that is within the threshold distance of the first portion of the route, and proactively requests respective data associated with the restaurant (e.g., to display operating hours, contact information, menus, acceptance of credit cards, user ratings, user reviews, cost estimates, and/or other information associated with the restaurant). In some embodiments, the one or more criteria include a criterion that is satisfied based on previous user interaction with the electronic device. For example, the electronic device optionally detects that a user of the electronic device tends to and/or has interacted with steakhouse restaurants, and accordingly requests respective map data associated with a steakhouse near the route. Proactively requesting data for points of interest in proximity to the route that satisfy the one or more criteria reduces the need for user input manually obtaining such data, enables a more feature rich experience despite potential lapses in network coverage, and/or reduces the power consumption required and the time to download or otherwise to obtain such data.

In some embodiments, the one or more second criteria include a criterion that is satisfied based on one or more factors associated with a communication network of the electronic device in areas between the one or more POI and the first portion of the route, such as a network of electronic device 500 and indicated by indication 612 as shown in FIG. 6F. For example, the electronic device optionally determines that a cellular data network within a respective area between a respective POI of the one or more POI and the route is weak and/or lacking, and accordingly downloads data to route toward and/or display information associated with the respective POI. Thus, the one or more second criteria optionally include a criterion that is satisfied based on one or more characteristics of the communication network of the electronic device, such as a strength of a network, latency of the network, an anticipated power of a respective signal received at the electronic device received from the network, jitter, packet loss, and/or signal quality of the network. In some embodiments, the one or more characteristics of the communication network are based on a historical record of the one or more characteristics in the areas between the one or more POI. In some embodiments, the amount of data included in the first map data is modified in accordance with the one or more characteristics of the network. For example, although a network quality optionally is high latency within the respective area between the respective POI and the first portion of the route, the communication network optionally is sufficient to at least partially stream data to the electronic device. As such, the electronic device optionally obtains a relatively lesser amount of data proactively (e.g., included in the first map data in accordance with the satisfaction of the second one or more criteria), and optionally uses a combination of data streamed to the device and the first map data to display information (e.g., routes, descriptive information, graphical representations) of the respective point of interest while in the area between the respective POI and the first portion of the route. In some embodiments, the electronic device determines that the cellular data network within the respective area between the respective POI of the one or more POI and the route is sufficient such that the electronic device communicates a request to download data on an as needed basis (e.g., streams the map data) and forgoes the use of and/or the communication of the request for the first map data. Requesting respective map data associated with one or more POI in the first map data in accordance with a determination that a respective criterion is satisfied based on one or more factors associated with the communication network of the electronic device reduces the need for user input manually obtaining such data, enables a more feature rich experience despite potential lapses in network coverage, and/or reduces the power consumption required to obtain such data in areas where network coverage is lacking and/or insufficient.

In some embodiments, a respective POI is associated with the first portion of the route, such as indication 618-1 as shown in FIG. 6E. For example, a respective POI (e.g., business, restaurant, rest stop, and/or facility) is along a road included in the first portion of the route and/or is within a threshold distance (e.g., 0.01, 0.05, 0.1, 0.5, 1, 5, 10 15, 20, 25, 50, 100, 250, 500, 1000, 10000, or 100000 m) of the route, and is thus associated with the first portion of the route.

In some embodiments, while the navigation along the route is initiated the electronic device receives, via the one or more input devices, a first input corresponding to a request to view information associated with the respective POI, such as contact 610 as shown in FIG. 6E. For example, the electronic device optionally displays a visual representation of the respective POI, such as a silhouette of the POI, a rectangular or circular graphical object, a name of the respective POI, a graphical flag or marker overlaid over a location of the respective POI in the map, and/or the like, and detects a selection input directed at the visual representation of the respective POI, as described previously an omitted here for brevity.

in some embodiments, in response to receiving, via the one or more input devices, the first input in accordance with the determination that the electronic device has received the first map data, the electronic device displays, via the display generation component, the information associated with the respective POI using the first map data, such as banner 632 as shown in FIG. 6F. For example, in accordance with a determination that one or more criteria are satisfied including a criterion that is satisfied when the first map data has previously been received (e.g., and/or is stored locally to the electronic device, and/or another electronic device in communication with the electronic device, such as an infotainment system in communication with the electronic device) and/or a criterion that is satisfied based on one or more factors associated with a communication network of the electronic device similar to as described herein, but with relative to a current area of the user (e.g., rather than areas between the one or more POI and the first portion of the route). In one such example, the electronic device optionally determines that the first input includes a selection input directed to a representation of a restaurant, and if the first map data that was previously downloaded includes information describing the restaurant, optionally displays at least a portion of the information describing the restaurant in response to the selection input and optionally without transmitting, outside of the electronic device such as to a server, additional requests for map data that optionally are required to display the information. Thus, the electronic device uses locally stored first map data to provide a feature rich user experience to view and interact with a maps application. For example, in response to the first input and if the one or more criteria are satisfied, the electronic device optionally displays a visual representation of an informational card describing the respective POI solely relying on the first map data that was previously downloaded. The informational card optionally includes information such as representations of the metadata described herein. In some embodiments, the first input is received and the criterion that is satisfied based on the one or more factors associated with the communication network of the electronic device is not satisfied (e.g., the cellular network of the electronic device at the device's current location is sufficient to stream data), but because the first map data has been previously obtained including the information associated with the respective POI, the electronic device forgoes streaming of additional data via the communication network, and instead displays the information associated with the respective POI using the locally stored first map data.

In some embodiments, in accordance with the determination that the electronic device has not received the first map data, the electronic device displays, via the display generation component, the information associated with the respective POI using the third map data streaming to the electronic device, such as the banner 632 as shown in FIG. 6F. For example, the electronic device optionally determines that the first map data has not been previously downloaded at a time the first input is received, and optionally communicates a request for third map data (corresponding to the first map data) to a device external to the electronic device, such as a server. A second electronic device in communication with the electronic device optionally receives the request, and transmits the third map data to the electronic device. The electronic device optionally receives the third map data, and optionally in response to receiving the third map data, optionally displays the information associated with the respective POI. In some embodiments, the third map data optionally includes additional data that is not included in the corresponding first map data. For example, media (e.g., videos) that presents a heavy storage load on the electronic device optionally is not included in the first map data that is optionally stored at the first electronic device, but the optionally is included in the third map data. Using the first map data to display information associated with the respective POI reduces the need for the electronic device to communicate to other electronic devices for similar data, thereby reducing latency of user interaction and reducing power consumption required to retrieve the similar data.

In some embodiments, the first map data and the second map data include information associated with a history of traffic along the first portion of the route and the second portion of the route, respectively, such as a history of traffic along portion 628 of the route as shown in FIG. 6H. For example, the first map data optionally includes historical traffic data along respective portions of the route and/or indications of such historical traffic data. In some embodiments, a second electronic device provides a history of traffic. For example, the second electronic device optionally collected traffic data at respective intervals of time (e.g., 0.01, 0.05, 0.1, 0.5, 1, 5, 10, 15, 25, 50, 100, 500, 1000, or 5000 seconds) within areas of an environment. When the electronic device transmits the first request to transmit the first map data, the second electronic device optionally sends at least a portion of the history of traffic to the electronic device. Thus, the electronic device receives historical traffic data of an environment of the electronic device, and optionally presents an indication of such traffic using the first and/or second map data stored locally to the electronic device (e.g., instead of communicating request(s) for real time traffic data). It is understood that the historical traffic data optionally is a subset of the traffic data available to the second electronic device. For example, the electronic device optionally receives traffic data relevant to the route (e.g., included in the route) and/or receives traffic data corresponding to anticipated times that the electronic device optionally will be located at respective portions of the route. When displaying, via the display generation component, a respective portion of the route and if the electronic device has respective traffic data associated with the respective portion of the route, the electronic device optionally displays a representation of such traffic (e.g., an amount of potential delay in estimated arrival time and/or a color such as a red or orange color along the respective portion of the route). It is understood that the foregoing embodiments optionally apply to respective traffic data corresponding to the first portion of the route and the second portion of the route, in addition to other potential portions of the route. Requesting historical traffic data in the first map data and/or second map data improves user awareness about potential delays in arrival times at respective destinations that the user otherwise would not be aware of, for example, if the electronic device is in an area that lacks sufficient network coverage to obtain real-time traffic data.

In some embodiments, the first map data and the second map data include information associated with one or more route closures along the route present at a time the user input initiating the navigation along the route is received, as shown by indication 620 as shown in FIG. 6H. For example, a forestry service, a highway service, and/or another entity optionally designates that a respective road or portion of a road is closed, and while such road closures are available, the electronic device detects the first input, and obtains an indication of such closures as a part of the first and/or second map data. Thus, the electronic device optionally proactively obtains an indication of potential road closures, and optionally displays indications of such closure and optionally provides alternative routes independent of an availability of a communication network of the electronic device. For example, the electronic device optionally displays a graphical representation of such a road closure (e.g., an icon corresponding to a “do not enter” street sign”). In some embodiments, in response detecting a second input requesting an alternative route toward the initial destination of the route, the electronic device accordingly proposes an alternative route that does not direct the user toward a respective road closure. Thus, the electronic device optionally provides the user with an indication of road closures and allows the user to avoid such closures, even if the electronic device lacks a sufficient wireless communication network to obtain such indications. In some embodiments, the first map data and/or the second map data include information describing a state of a respective road, a status describing the respective road, and/or construction associated with respective road. Requesting indications of one or more route closures in the first and second map data allow the user to avoid situations in which the electronic device navigates toward and/or along the closed portions of the route due to a status of the road that is unknown to the user in the absence of the first map data, thereby reducing the need for processing to determine an alternate route.

In some embodiments, while the navigation along the route is initiated and while the position of the user corresponds to the first portion of the route and the first portion of the route satisfies the one or more criteria, receiving, via the one or more input devices, a first input adding navigation toward a respective POI associated with the first portion of the route to the navigation along the route, such as contact 610 as shown in FIG. 6G. For example, as described herein, the electronic device optionally determines a selection of a representation of a respective POI. In some embodiments, in response to such a selection, the electronic device displays one or more selectable options to update the route to navigate toward the respective POI. In some embodiments, in response to the selection, the electronic device displays a respective informational card associated with the POI, and detects a selection of a respective selectable option to display selectable options to update the route. In some embodiments, the electronic device optionally adds (e.g., to the existing route) navigation toward the respective POI in response to the selection of the representation of the POI. In the foregoing embodiments, display of visual indications, information, and modification of the route optionally are accomplished partially or entirely using previously obtained (e.g., first and/or second) map data. Thus, even if network coverage within the first portion of the route is insufficient to seamlessly insert navigation toward a POI and update navigation along the route, the electronic device optionally provides such interactivity and features using previously downloaded map data. Similar or the same treatment applies to input received while the user location corresponds to the first portion of the route and/or the second portion of the route, in addition to other respective portions of the route for which the electronic device has respective map data.

In some embodiments, in response to receiving, via the one or more input devices, the first input, modifying the navigation along the route to include navigation toward the respective POI, such as the modification as shown in FIG. 6H. For example, the electronic device optionally updates an indication of an estimated time of arrival, a distance, a travel time, a graphical representation of the route, and/or of a next direction along the route in response to first input. In some embodiments, the electronic device additionally inserts one or more navigational directions to first navigate toward the respective POI and then navigate from the POI to an original next stop or destination of the route. Adding navigation toward a respective POI while the user location corresponds to the first portion of the route allows the user to update the route, despite any insufficiency of a communication of the electronic device, and allows the device to preserve power consumption otherwise required to communicate requests for data to perform the updated navigation.

In some embodiments, the one or more criteria include a criterion that is satisfied when a respective portion of the route is within a threshold distance (e.g., 0.01, 0.05, 0.1, 0.5, 1, 5, 10 15, 20, 25, 50, 100, 250, 500, 1000, 10000, or 100000 m) of a destination of the route, such as a destination of the route as shown in FIG. 6E. For example, the electronic device optionally proactively downloads respective map data surrounding a destination of the route when obtaining respective map data. For example, a user of the electronic device may be routed to a destination that includes a crowded wireless spectrum due to other electronic devices transmitting and receiving respective signals. Thus, the electronic device optionally downloads respective map data around the destination of the route such that despite environmental factors (e.g., buildings, other devices, and/or metal structures) that optionally delay receipt of streamed map data to the electronic device while the user is located at the destination, the device optionally leverages the previously obtained map data to display points of interest, public transportation information, and other information associated with the map data. Proactively communicating a request for respective map data surrounding the destination of the route reduces the need for communicating similar request while and/or after the user reaches the destination.

In some embodiments, the one or more criteria include a criterion that is satisfied based on one or more characteristics of a respective portion of a communication network of the electronic device along a respective portion of the route, such as a communication network of the electronic device 500 as shown in FIG. 6E. For example, the one or more characteristics optionally include a strength of a network, latency of the network, an anticipated power of a respective signal received at the electronic device received from the network, jitter, packet loss, and/or signal quality of the network (e.g., in and around the respective portion of the route). In some embodiments, such one or more characteristics are based on historical data known to the electronic device (e.g., from an entity responsible for the network). For the example, a respective criterion of the second or more criteria optionally is satisfied when the respective portion of the communication network includes an amount of signal sources (e.g., transmission towers such as cellular towers) fewer than a threshold amount of signal sources and/or is satisfied based on a relative spacing between respective signal sources (e.g., between transmission towers). Thus, in some embodiments, if wireless network coverage (e.g., cellular coverage) is insufficient along a respective portion of the route, the electronic device proactively initiates a process to communicate a request for map data that corresponds to the respective portion of the route. Another respective criterion optionally is satisfied when the respective portion of the route includes one or more geographic features (e.g., forests, hills, and/or mountains) that optionally impede signal propagation. In some embodiments, in accordance with a determination that the one or more criteria are satisfied, the electronic device optionally initiates a process to communicate a request to proactively obtain respective map data corresponding to the respective portion of the route. In some embodiments, in accordance with a determination that the one or more criteria are not satisfied, the electronic device optionally forgoes initiating the process to communicate the request to obtain the respective map data. Obtaining first map data in accordance one or more characteristics of a respective portion of a communication network reduces the likelihood that the user will be unable to access map information while within a respective portion of a route corresponding to the respective portion of the communication network.

It should be understood that the particular order in which the operations in FIGS. 7A-7B has been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIGS. 7A-7B is, optionally, implemented by components depicted in FIGS. 1A-1B. For example, receiving operation 702a, initiating operation 702b, transmitting operation 702e, and transmitting operation 702h are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Primary and Supplemental Map Suggestions

Users interact with electronic devices in many different manners. The embodiments described below provide ways in which an electronic device suggests one or more maps to download based on a user interaction, and subsequently downloads a primary map and one more supplemental maps associated with the primary map in accordance with user input. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

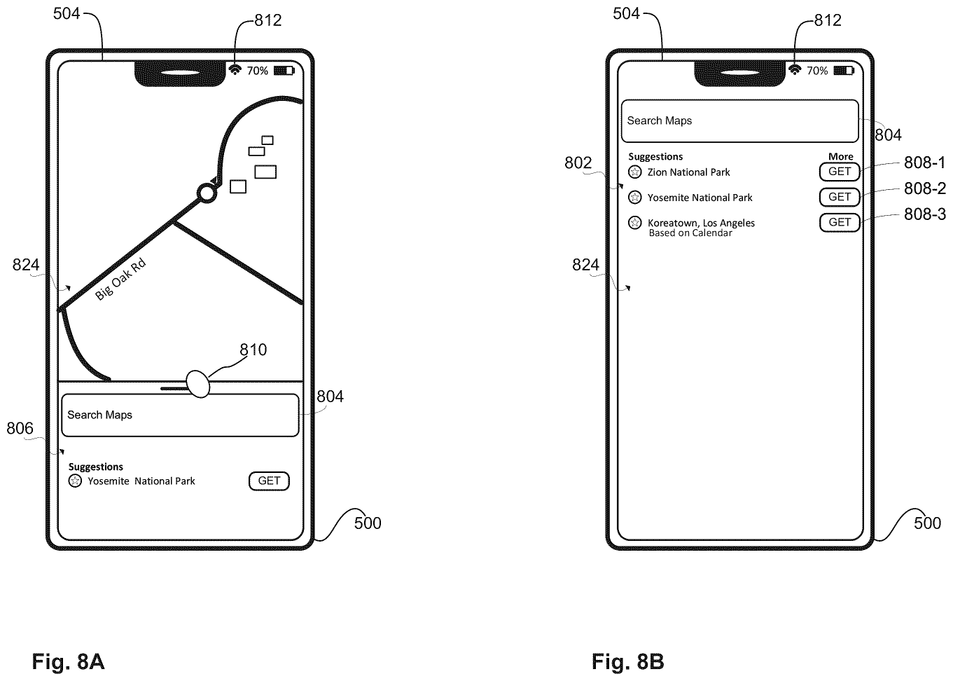

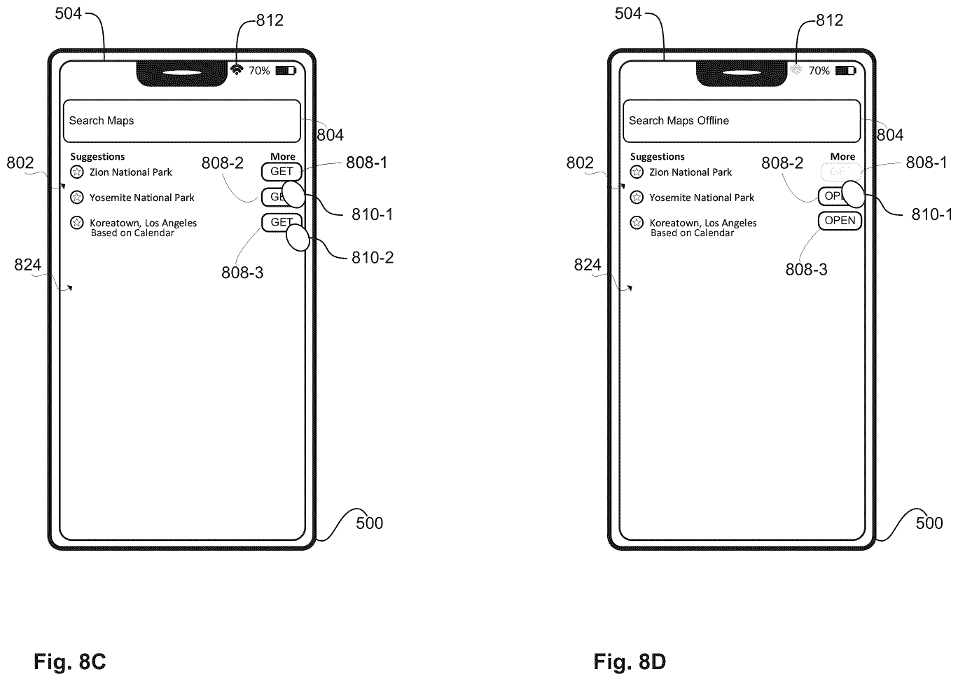

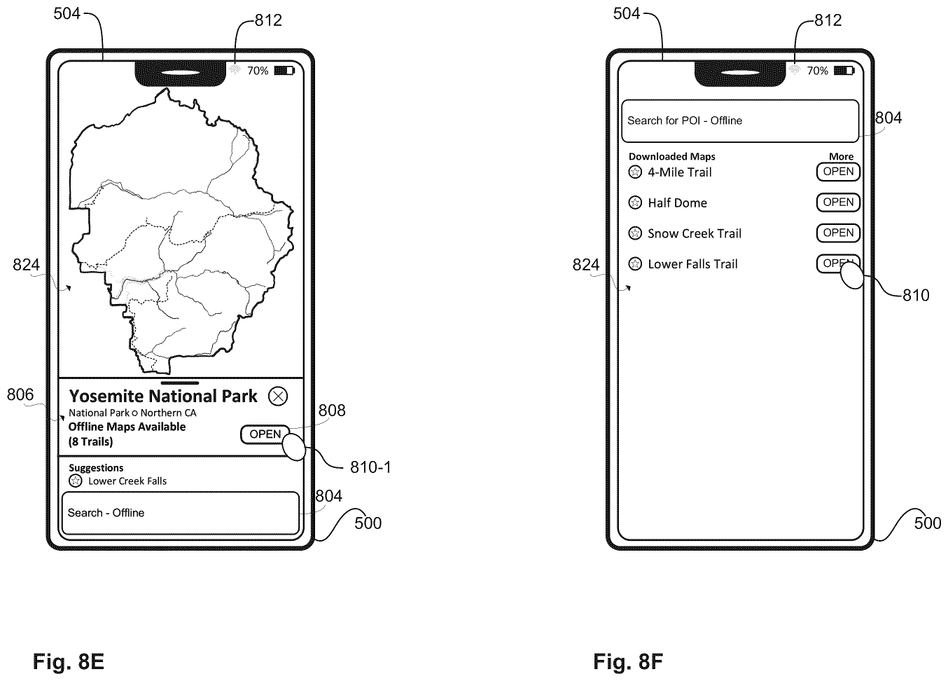

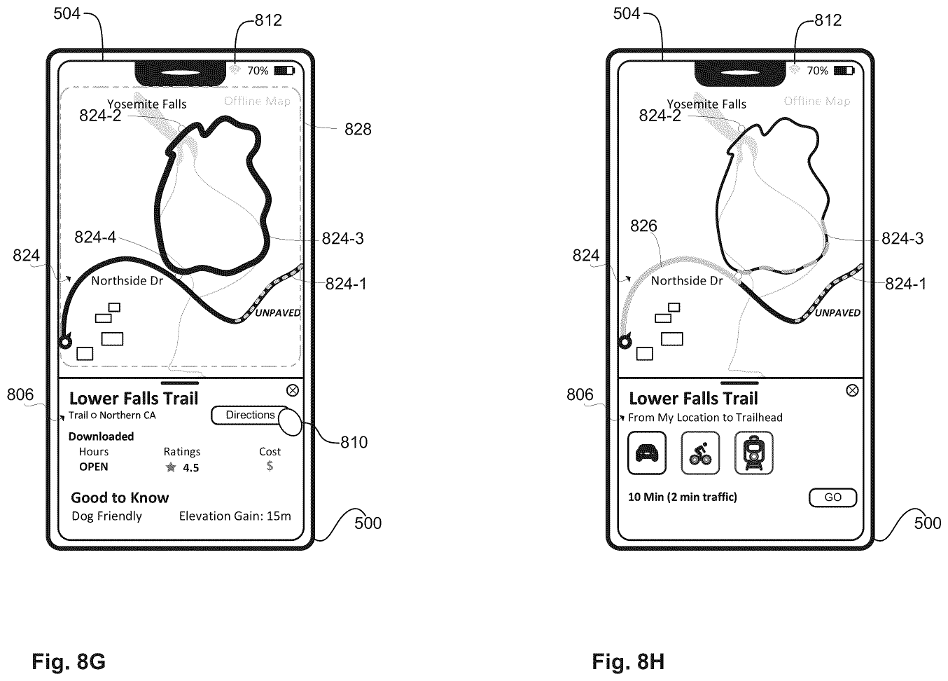

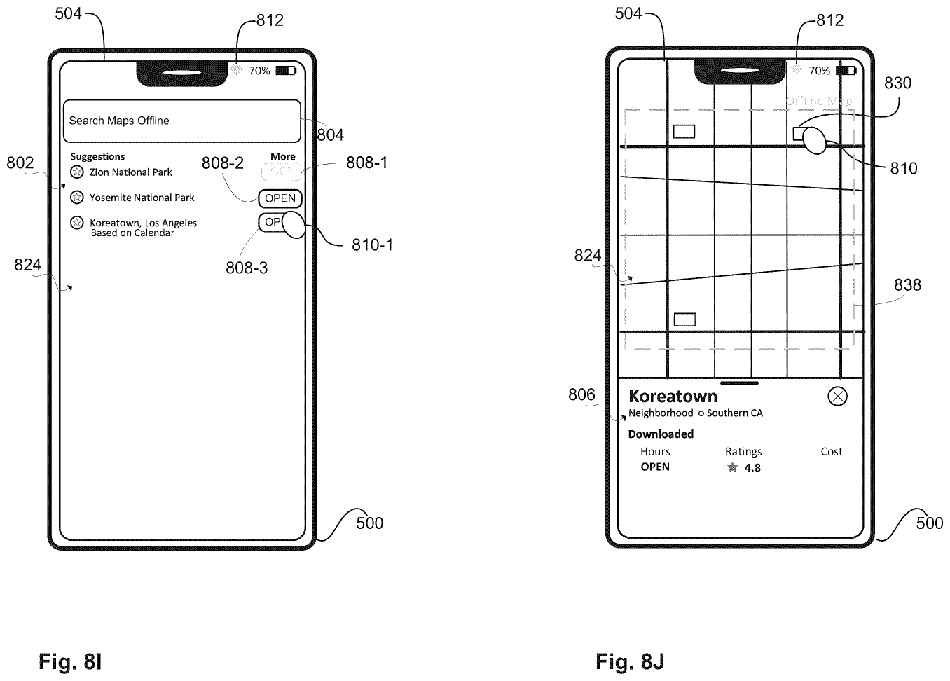

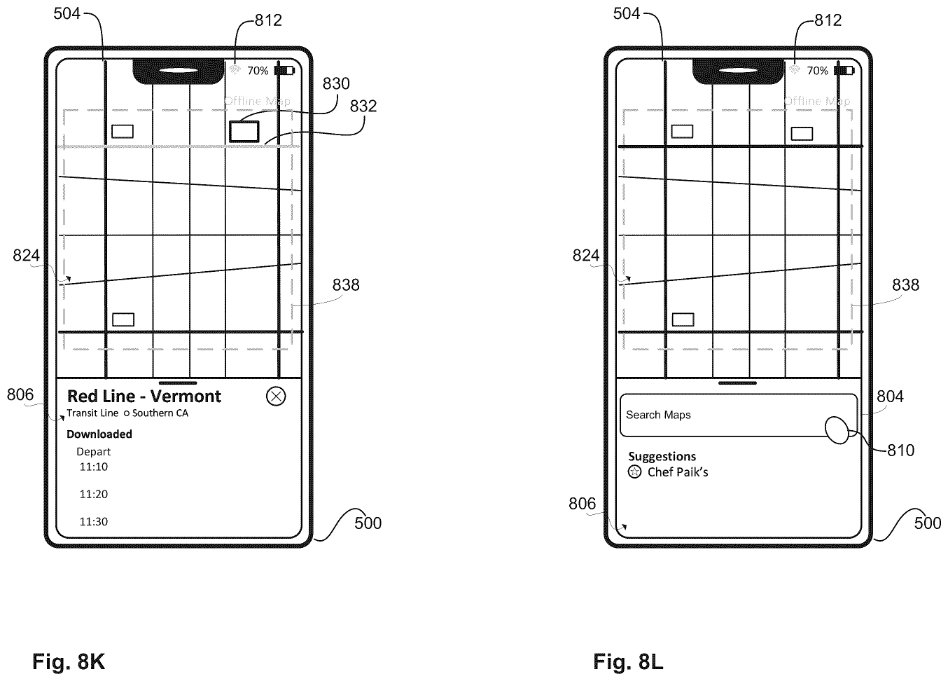

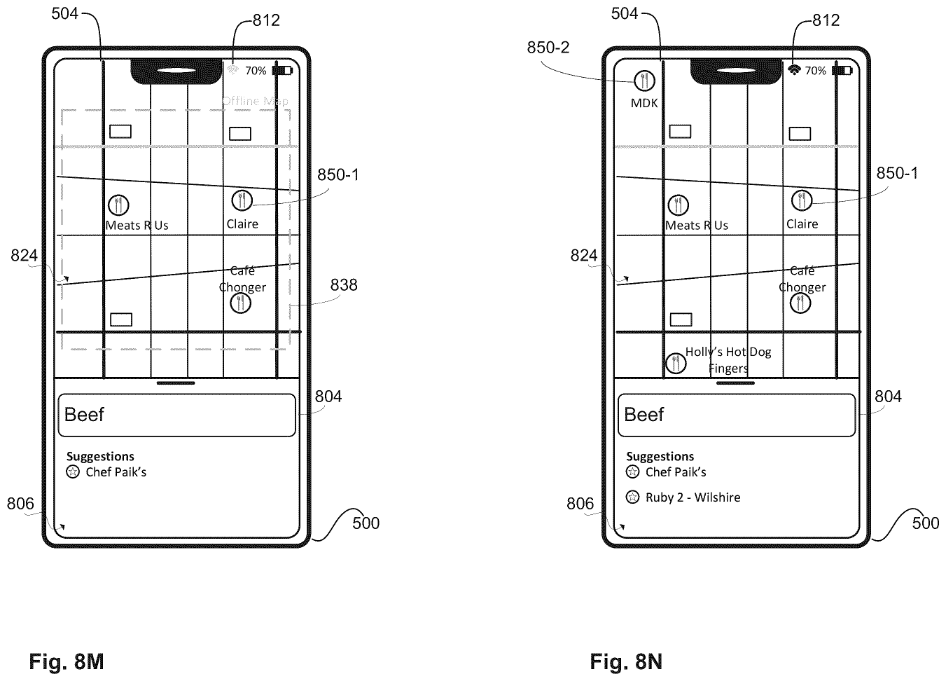

FIGS. 8A-8N illustrate exemplary ways in which an electronic device suggests one or more maps to download based on a user interaction, and subsequently downloads a primary map and one more supplemental maps associated with the primary map in accordance with user input in accordance with some embodiments of the disclosure. The embodiments in these figures are used to illustrate the processes described below, including the processes described with reference to FIG. 9. Although FIGS. 8A-8N illustrate various examples of ways an electronic device is able to perform the processes described below with reference to FIG. 9, it should be understood that these examples are not meant to be limiting, and the electronic device is able to perform one or more processes described below with reference to FIG. 9 in ways not expressly described with reference to FIGS. 8A-8N.

In some embodiments, an electronic device has knowledge of a history of user interactions with the electronic device, and presents one or more first maps for download to the user based on such a history. In some embodiments, in response to user input, the electronic device obtains offline map data corresponding to a first map (e.g., a primary map), and in accordance with a determination that the first map is associated with one or more second maps (e.g., one or more supplemental maps), the electronic device proactively obtains second map data associated with the one or more second maps. In some embodiments, using previously obtained first and/or second map data, the electronic device displays a user interface suggesting representations of the first map and/or one or more second maps based on historical activity of a user interacting with the electronic device. In some embodiments, such suggestions are generated using the offline map data, independent of a communication network (e.g., while the electronic device is offline). Further descriptions of such functionality follow.

In FIG. 8A, device 500 displays a user interface of a map application via display 504 while online and/or sufficiently connected to a network (e.g., a wireless network such as a cellular data and/or Wi-Fi network), as indication by indication 812. In some embodiments, the electronic device 500 displays a user interface 824, and in response to a request to initiate a search query, displays banner 806. In some embodiments, banner 806 includes search field 804. In some embodiments, banner 806 displays one or more suggested maps based on a history of user interaction (e.g., based on their previous searches in the mapping application, previous locations viewed within the map application, previous map downloads, calendar information, email information, and/or other pertinent aspects of their interactions with the electronic device 500). In response to detecting contact 610 to expand banner 806, the electronic device displays a plurality of suggested maps 802 for the user to download as shown in FIG. 8B. Selectable options 808-1, 808-2, and 808-3 are displayed, and are respectively selectable to initiate a download of a primary map associated with each named map. For example, “Koreatown” is included in the suggested maps 802 based on a calendar application stored on the electronic device 500, and is displayed with selectable option 808-3 to download map data associated with Koreatown.

In FIG. 8C, the electronic device 500 detects contacts 810-1 and contact 810-2 to initiate a download of respective map data associated with the respective maps. In some embodiments, the electronic device 500 downloads map data corresponding to a selected, respective map, and additionally downloads map data corresponding to one or more supplemental maps that are associated with the respective map. For example, the electronic device 500 optionally downloads one or more trail maps associated with Yosemite National Park in addition to a primary map corresponding to Yosemite National Park in response to contact 810-1.

In FIG. 8D, after completing the download, the electronic device 500 is in an offline state (e.g., due to a manual input to go offline, due to an insufficient data network, and/or due to a congested data network). As such, the electronic device 500 displays selectable option 808-1 with a modified appearance to indicate the lack of interactability with the selectable option 808-1. In accordance with a determination that the electronic device has previously downloaded respective map data associated with “Yosemite National Park” and “Koreatown,” the electronic device optionally displays selectable options 808-2 and 808-3 with an updated appearance to “Open” respective maps. In some embodiments, the suggested maps 802 are suggested partially or entirely using a history of user interaction, and in some embodiments, are suggested for display independent of networking status (e.g., online or offline status) of the electronic device 500. For example, suggested maps 802 are optionally presented in accordance with the user's history, and optionally not necessarily with a previous suggestion of the same maps while the device was online (e.g., as shown in FIG. 8C). In FIG. 8D, the electronic device 500 detects a contact 810-1 to open a map associated with Yosemite National Park.

In FIG. 8E, in response to the input to open the map of Yosemite Park, the electronic device 500 displays user interface 824, included in an “information card” associated with Yosemite Park. In some embodiments, the electronic device concurrently displays a banner 806 with respective information describing user interface 824, and a selectable option 808 to display one or more supplemental maps associated with Yosemite National Park. In response to detecting contact 810-1 directed to selectable option 808, the electronic device 500 optionally displays one or more supplemental maps associated with Yosemite National Park.

In FIG. 8F, the electronic device 500 displays a plurality of trail maps associated with Yosemite in response to the previous contact, and further detects contact 810 to initiate display of a supplemental map (e.g., a trail map) that was previously downloaded in response to the input to download the map of Yosemite. As such, the display of the supplemental map optionally is performed while the electronic device 500 is “offline” (e.g., without a sufficient communication network connection) using the downloaded data (e.g., without using data that is streaming in real-time, or nearly real-time to the electronic device 500).

In FIG. 8G, the electronic device 500 displays a user interface 824 including an information card (e.g., a visual representation of a map of a point of interest and/or respective information associated with the point of interest) in response to the contact to initiate display of the supplemental map (e.g., a map of “Lower Falls Trail”). For example, the information card optionally corresponds to a trail (e.g., “Lower Falls Trail”). In some embodiments, the information card displayed in user interface 824 includes a map corresponding to the point of interest. In some embodiments, border 828 is not shown, but illustrates an area within which network coverage optionally is insufficient for data streaming. The electronic device 500 optionally instead of streaming data, uses the previously downloaded data to display names of streets, display indications of points of interest within the supplemental map such as indication 824-2, and/or 824-4, display indication 824-1 of road quality, display a trail 824-3 included within the supplemental map, and/or other information included in banner 806. In some embodiments, the electronic device 500 detects a contact 810 directed to a selectable option (e.g., “Directions) to initiate navigation toward a destination within the supplemental map using the previously downloaded map data to generate a route toward the destination.

In FIG. 8H, in response to the contact initiating navigation, the electronic device 500 displays a route preview in user interface 824. In some embodiments, the route preview shown in banner 806 includes one or more modes of transportation (e.g., walking, cycling, biking, driving, and/or public transportation) associated with the supplemental map using the previously downloaded map data. In some embodiments, the electronic device 500 visually distinguishes a portion 826 of a route (e.g., with a color, border, thickness, and/or another visual effect) to a destination of the user. In some embodiments, the route additionally includes granular map information, such as information to display a trail route 824-3 to the user.

In some embodiments, the electronic device 500 additionally or alternatively obtains offline map data to display transit information included within a region of a primary and/or a supplemental map, and or information to search for points of interest within the primary and/or supplemental map. For example, in FIG. 8I, the electronic device 500 optionally displays a user interface 824 including a plurality of suggested offline maps, wherein the suggested maps are optionally determined in accordance with a history of user interaction with the electronic device 500 (e.g., as described previously). Contact 810-1, for example, is directed to selectable option 808-3, and in response to detecting contact 810-1 the electronic device 500 optionally displays a primary map, as shown in FIG. 8J.

In FIG. 8J, the electronic device 500 displays a map of Koreatown, Los Angeles including a plurality of representations of public transportation hubs (e.g., bus stops, subway stations, and/or train stations) included in previously downloaded map data, such as representation 830. In some embodiments, in accordance with a determination that the electronic device lacks map data corresponding to the region circumscribed by border 838 (e.g., a border that is optionally displayed or optionally is not displayed, and is illustrative of a border of the offline map data), the electronic device 500 forgoes display of representation 830. In some embodiments, in response to detecting a selection of representation 830, the electronic device 500 displays respective information included in banner 806, as shown in FIG. 8K. In some embodiments, the respective information includes one or more timetables of a public transportation route (e.g., a bus route, a subway line, and/or shuttle route). In response to the selection, the electronic device 500 optionally also visually distinguishes the route 832 of the public transportation route.

In FIG. 8L, the electronic device 500 performs searching using offline map data. For example, the electronic device 500 optionally displays a search field 804 within banner 806 while offline, as indicated by indication 812. In response to detecting input including contact 810 directed to search field 804, and input entering a query and/or search term(s), the electronic device 500 displays one or more representations of respective points of interest based on previously downloaded offline map data. For example, representation 850-1 optionally is displayed in response to a query (e.g., “beef”) based on offline map data. In some embodiments, in response to an input selecting representation 850-1, the electronic device displays respective information (e.g., an informational card) associated with the representation 850-1, as described further with reference to method 900 and below. In some embodiments, the electronic device 500 receives the same query while online, as shown in FIG. 8N, and displays additional search results due to access to data not included in the offline map data. For example, representation 850-2 optionally is displayed, and selectable, similarly as described with reference to representation 850-1, using data that is streamed to the electronic device 500.

In some embodiments, the electronic device 500 detects a query while the device is online (e.g., connected to a communication network). In response to the query, the electronic device 500 optionally displays a representation of a map associated with the query. For example, the query optionally corresponds to a city, park, point of interest such as a landmark, a neighborhood, and/or another suitable map, and the electronic device 500 optionally displays text and/or graphics representing search results based on the query. In some embodiments, the electronic device 500 detects an input directed to a respective search result, and in response to the input, displays the map. In some embodiments, a first portion of the map is displayed with a first visual appearance (e.g., colorspace, saturation, hue, transparency, an amount of blurring effect, and/or another visual quality or effect) and a second portion of the map is displayed with a second visual appearance (e.g., a different colorspace, saturation, hue, transparency, amount of blurring effect, and/or another visual quality or effect) such that the first portion and the second portion are visually distinct. In some embodiments, the first portion corresponds to a respective portion associated with the query, such as the city limits corresponding to the queried city. In some embodiments, the second portion corresponds to an area outside the query. In some embodiments, the first and/or second portion are determined in accordance with a border and/or boundary of the displayed map, such as the border of a regional park. In some embodiments, one or more selectable options are displayed. In response to a selection and/or modification of a position of a respective selectable option, the electronic device 500 optionally modifies the size and/or scale of the first and/or second portions. For example, the electronic device optionally displays a border surrounding the first portion having a rectangular or semi-rectangular shape, and optionally displays one or more “grabber” elements to expand the dimensions of the border. In response to detecting a respective selection and/or movement (e.g., a contacting of a touch screen and/or movement of the contact) of a respective grabber element, the electronic device 500 optionally expands and/or contracts the border, and correspondingly modifying the areas included in the first and/or second portion of the map. In some embodiments, the electronic device 500 displays a visual element that is selectable to download map data corresponding to the first portion of the map (but not the second portion of the map), and in response detecting a selection of the visual element, initiates a download of the map data corresponding to the first portion of the map (but not the second portion of the map).

FIG. 9 is a flow diagram illustrating a method 900 of exemplary ways of obtaining map data associated with a primary map and one or more supplemental maps, such as in FIGS. 8A-8N. The method 900 is optionally performed at an electronic device such as device 100, device 300, or device 500 as described above with reference to FIGS. 1A-1B, 2-3, 4A-4B and 5A-5H. Some operations in method 900 are, optionally combined and/or order of some operations is, optionally, changed.

As described below, the method 900 provides ways to suggest map data for download, and download a suggested map in addition to supplemental maps associated with the suggested map. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, a method 900 is performed at an electronic device, such as device 500 shown in FIG. 8A, in communication with one or more input devices and a display generation component, such as display 504. For example, the electronic device is a mobile device (e.g., a tablet, a smartphone, a media player, or a wearable device) including a touch screen and wireless communication circuitry, or a computer including one or more of a keyboard, mouse, trackpad, and touch screen and wireless communication circuitry and optionally has one or more of the characteristics of the electronic device of method 700. In some embodiments, the display generation component has one or more characteristics of the display generation component in method 700. In some embodiments, the input device has one or more characteristics of the one or more input devices in method 700. In some embodiments, method 900 is performed at or by an automobile (e.g., at an infotainment system of an automobile having or in communication with one or more display generation components and/or input devices).

In some embodiments, the electronic device, such as device 500, displays (902a), via the display generation component, a user interface, such as user interface 824 as shown in FIG. 8A, including one or more visual representations corresponding to first one or more maps, such as suggested maps 802, wherein a first respective map of the first one or more maps is included in the first one or more maps based on historical activity of a user of the electronic device, such as a history of interaction with electronic device 500 as shown in FIG. 8B. For example, the user interface optionally corresponds to a user interface of an application (e.g., a map application) installed on the electronic device and/or another device in communication with the electronic device and includes one or more graphical and/or textual representations of the first one or more maps. For example, one or more respective maps of the first one or more maps optionally are represented by a graphical icon such as a picture and/or text showing a name and/or a description associated with the map (e.g., a description of the geographic region included in the map). In some embodiments, one or more of the first one or more maps correspond to geographic regions, such as national or state parks. In some embodiments, one or more of the first one or more maps correspond to towns, cities, and/or roads. In some embodiments, one or more of the first one or more maps correspond to maps of geographic areas of interest, such as deserts, rivers, lakes, oceans, and/or mountains. In some embodiments, one or more of the first one or more maps correspond to a point of interest, such as a vista, a landmark, and/or a thematically linked collection of such points of interest. In some embodiments, the one or more maps include any combination of the previously described maps. In some embodiments, respective visual representations corresponding to the response one or more maps are displayed in response to a user input, such as a user input initiating a search function of the application. In some embodiments, the electronic device displays (e.g., suggests) respective visual representations in response to a determined context of the user and/or electronic device. For example, while interacting with a mapping application (e.g., the map application), the electronic device optionally determines that the current context of the user corresponds to a currently displayed portion of the mapping application (e.g., a currently displayed region of a map in the map application) and displays selectable icons corresponding to maps relevant to the displayed portion of the mapping application. In some embodiments, the electronic device is aware of (optionally past) user interaction with the electronic device, the map application and/or other aspects of user activity with other electronic devices. For example, optionally contingent upon an indication of user approval previously received at the electronic device, the electronic device optionally accesses user activity including historical data associated with the mapping application such as previous searches, previously viewed portions of maps, previously saved points of interest (e.g., landmarks, restaurants, and/or cities), previous navigation routes, and/or other data indicative of user interests broadly. Additionally or alternatively, optionally contingent upon user approval, the electronic device optionally accesses user activity including data from one or more applications stored on the electronic device or in communication with the electronic device, such as a calendar application and/or an email application, and optionally determines one or more maps potentially are of interest to the user (e.g., because they are related to the previously-described activity of the user). For example, the first respective map optionally corresponds to a national park proximate to a previously searched term (e.g., town, city, or region), a neighborhood near an airport listed in the user's calendar, and/or a public transportation map of a city the user previously marked as a favorite. In some embodiments, based on the historical data and/or other indications of user interest(s), the electronic device determines respective one or maps to include in the first one or more maps presented to the user via the display generation component. In some embodiments, the user interface and/or map application have one or more of the characteristics of the user interface and/or map application of method 700. Thus, the electronic device optionally suggests one or more maps for download based on a history of interaction with the electronic device.

In some embodiments, while displaying, via the display generation component, the one or more visual representations, the electronic device receives (902b), via the one or more input devices, an input selecting a first respective visual representation, such as a representation of suggested maps 802 in FIG. 8B, wherein the first respective visual representation is associated with the first respective map, such as the map as shown in FIG. 8E in user interface 824. For example, the electronic device optionally detects an indication of an input selecting a visual representation corresponding to a map. In some embodiments, the electronic device detects selection input such as a contact at a surface (e.g., touch sensitive surface), a gesture directed towards the visual representation, gaze of the user directed to the visual representation, and/or another suitable input directed towards the visual representation and in response, initiates one or more functions. In some embodiments, the electronic device displays a second user interface associated with the selected first respective visual representation in response to the selection input of the visual representation including a selectable option to download the first respective map. In some embodiments, the selectable option to download is not readily visible within the second user interface (e.g., is not initially displayed in the second user interface), but is displayed in response to further interaction/selection of respective visual representations within the second user interface and/or additional third user interface(s).

In some embodiments, in response to receiving, via the one or more input devices, the input selecting the first respective visual representation (902c), the electronic device transmits (902d) (e.g., to a server external to the electronic device) a request to download first map data associated with the first respective map, such as a supplemental map of “Lower Falls Trail” as shown in FIG. 8F. For example, the electronic device optionally communicates a request to download geolocation and/or map data associated with the first respective map. In some embodiments, the first map data includes data mapping a first geographic region. In some embodiments, the request and/or the first map data have one or more characteristics of the request for map data and/or map data described with respect to method 700.

In some embodiments, in accordance with a determination that second one or more supplemental maps, other than the first one or more maps, are associated with the first respective map, such as the representations of trail maps as shown in FIG. 8F, the electronic device transmits (902e) a request to download second map data associated with the second one or more supplemental maps, such as map data associated with a respective supplemental map as shown in FIG. 8F and in FIG. 8G. For example, the first map data and/or the second map data optionally includes geographic, geologic, population, structural, hydrologic, traffic, navigational, cartographic data, and/or metadata associated with such data. In some embodiments, the map data included within the second one or more maps has one or more characteristics of the map data described with respect to method 700. In some embodiments, the first region includes one or more supplemental areas of potential interest to the user, and the first map data further includes supplemental map data corresponding to the one or more supplemental areas. For example, the electronic device optionally requests first map data corresponding to a region including a national park, and the supplemental map data optionally includes data such that the electronic device can display, via the display generation component, maps of one or trails, routes of interest, elevation data, and/or waterways within the region, such information optionally not included in the first map data. In some embodiments, prior to transmitting the request to download the first map data (e.g., before and/or without receiving the input selecting the first respective visual representation) and while the visual representation of the first respective map is displayed within the user interface (e.g., while the map application is displaying the geographic region of the map corresponding to the first respective map), the user interface and/or displayed geographic region does not include representations of information from the second one or more supplemental maps. In response to selection of a selectable option that is selectable to download the second one or more supplemental maps and/or display information from the second one or more supplemental maps, the electronic device optionally downloads such supplemental maps and displays in the user interface representations of information from the second one or more supplemental maps. In some embodiments, the electronic device detects an input requesting display of a respective supplemental map of the second one or more supplemental maps. In response to the input, the electronic device optionally displays a representation of the respective supplemental map, such as a border surrounding the contents of the supplemental lap and/or representations of metadata describing characteristics of the supplemental map (e.g., name, elevation, points of interest, and the like). In some embodiments, the received first map data and/or the second map data is received (e.g., from a server) and stored for later use (e.g., when the device is offline and/or has a weak data connection). Thus, in some embodiments, the electronic device downloads the first map data and/or the second map data for offline use or in advance of when respective map data is needed or useful such that the electronic device displays highly granular, detailed, and/or interactive representations of maps at a later time without relying upon a data network. Requesting second map data corresponding to second one or more supplemental maps in accordance with a determination that the second one or maps are associated with a first respective map reduces user input otherwise required to obtain such second map data, and further avoids a situation where the supplemental map data is requested or discovered to exist later while the electronic device does not have access to the supplemental map data.

In some embodiments, the historical activity includes a previously received second input corresponding to a request to display a representation of a region associated with the first respective map, such as a request to view the maps shown in user interface 824 as shown in FIG. 8A, in FIG. 8E, and/or in FIG. 8G. For example, at a time prior to the receiving the input selecting the first respective visual representation, the electronic device detects user interaction with the electronic device as described herein. The electronic device optionally keeps a record of such user interaction, and accordingly suggests the first respective map based on such user interaction. As one example, the electronic device optionally detects that the user has previously performed a search and/or provided an input (e.g., a scrolling input) to cause display of a forest or a regional park within a maps application. As such, the electronic device optionally has a record of historical activity corresponding to input corresponding to a request to display a representation of a region (e.g., a forest). In some embodiments, the first respective map optionally is a similar forest, regional park, and the like, that is based on the record of historical activity, the electronic device selects the first respective map as an item of potential interest to the user and includes the first respective map in the first one or more maps. Similarly, the historical activity optionally corresponds to one or more requests to view a visual representation of information describing one or more businesses (e.g., one or more information cards corresponding to driving ranges and/or golf courses), and accordingly selects the first respective map (e.g., of a respective golf course). In some embodiments, the historical activity is a previous query within a maps application of the first respective map, a region included within the first respective map, and/or a region including the first respective map, and/or a request to display such query results. Displaying the first respective map based on historical activity of interaction with a region associated with the first respective map improves the likelihood that the first one or more maps are related to the user's interests, thereby reducing input to manually display such a respective map or browse for the respective map.

In some embodiments, the first map data includes transit information associated with the first respective map, such as transit data to show route 832 as shown in FIG. 8K. For example, the transmit information optionally includes information about routes, roads, and/or geographic features that affect the routes and/or roads. The transit information optionally includes temporary alternations to roads. For example, the first map data optionally includes information designating that flooding along a freeway has cause the freeway to be temporarily shut down. As such, the electronic device optionally can display a representation of such an alteration the freeway. Additionally or alternatively, the transit information optionally includes information describing road quality. In some embodiments, the transit information is associated with traffic data, as described herein. In some embodiments, the transit information includes information about one or more modes of transportation within the first respective map area. For example, a transit service optionally provides an indication that a portion of a road is particularly impacted by adverse weather conditions (e.g., snow and/or ice), which optionally is included within the first map data. Accordingly, the electronic device optionally displays a representation of the indication (e.g., by visually distinguishing a portion of the route corresponding to the indication). Including the transit information in the first map data reduces the need for user input manually obtaining such transit information.

in some embodiments, after transmitting the request to download the first map data associated with the first respective map, the electronic device receives, via the one or more input devices, the first map data, such as map data corresponding to maps as shown in FIG. 8E and FIG. 8G. For example, the first map data optionally is received at a first time from a second electronic device.

In some embodiments, after receiving the first map data, the electronic device receives, via the one or more input devices, a second input, such as contact 610 as shown in FIG. 6A. For example, the second input optionally includes a request to initiate navigation along a route as described with reference to method 700. In some embodiments, the route is at least partially or entirely included within a region of an environment of the first respective map.

In some embodiments, in response to receiving the second input in accordance with a determination that the electronic device satisfies one or more criteria, the electronic device displays, via the display generation component, a first representation of traffic, such as portion 628 of a route as shown in FIG. 6H, along the respective portion of the first respective map in accordance with first respective traffic data included in the first map data corresponding to historical traffic data along the respective portion of the first respective map, such as the traffic estimate included in banner 806 in FIG. 8H. For example, the one or more criteria include a respective criterion that is satisfied when the electronic is determined to be offline (e.g., lacking a connection to a wireless communication network) and/or determined to have insufficient coverage by a data network (e.g., the wireless communication network such as a cellular data network, like a cellular carrier). In some embodiments, the one or more criteria includes a respective criterion that is satisfied based on one or more characteristics that optionally include a strength of a network, latency of the network, an anticipated power of a respective signal received at the electronic device received from the network, jitter, packet loss, and/or signal quality of the network (e.g., in and around the respective portion of the first respective map). In some embodiments, such one or more characteristics are based on historical data known to the electronic device (e.g., from an entity responsible for the network, such as a cellular carrier). For the example, a respective criterion of the or more criteria optionally is satisfied when a respective portion of the communication network includes an amount of signal sources (e.g., transmission towers such as cellular towers) fewer than a threshold amount of signal sources and/or is satisfied based on a relative spacing between respective signal sources (e.g., between transmission towers) at regions corresponding to the respective portion of the first map. Another respective criterion optionally is satisfied when the respective portion of the route includes one or more geographic features (e.g., forests, hills, and/or mountains) that optionally impede signal propagation. Thus, the electronic device optionally determines that user experience interacting with a representation of the first respective map optionally will be improved (e.g., if the one or more criteria are satisfied) if the first map data stored locally to the electronic device is used (e.g., first respective map data such as historical traffic data included in the first map data). Accordingly, the electronic device optionally uses the first map data including the transit information to display a representation of the traffic data. In some embodiments, the traffic data has one or more characteristics of the historical traffic data described with respect to method 700. In some embodiments, an estimated time of arrival based on the historical traffic data is displayed in response to the second input. In some embodiments, the electronic device displays one or more proposed routes toward a destination in accordance with the second input (e.g., if the second input includes a designation of a destination), and displays one or more representation of historical traffic along respective portions of the one or more proposed routes. In some embodiments, respective estimated times of arrival based on the historical traffic data are displayed concurrently with respective one or more proposed routes. In some embodiments, the one or more proposed routes and the one or more representations of historical traffic using the first map data are displayed for a one or more modes of transportation (e.g., public transportation, biking, walking, and/or driving).

In some embodiments, in accordance with a determination that the electronic device does not satisfy the one or more criteria, the electronic device displays, via the display generation component, a second representation of traffic, such as the portion 628 described previously, different from the first representation, along the respective portion of the first respective map in accordance with respective traffic data not included in the first map data in accordance with second respective traffic data, different from the first respective traffic data, corresponding to current traffic data along the respective portion of the first respective map, such as if portion 628 as shown in FIG. 6H was generated using streamed data. For example, the electronic device optionally determines that the user experience while interacting with a representation of the first respective map optionally is well suited (e.g., if the one or more criteria are not satisfied) to at least partially using streamed, real-time and/or nearly real-time traffic data (e.g., second respective traffic data), and optionally communicates one or more requests for such streamed data. As such, the electronic device optionally partially and/or entirely forgoes use of the first map data, and displays representation of traffic as described with reference to the previous embodiments using the first map data, but instead using the streamed data, or a combination of streamed data and historical traffic data. Using the first respective traffic data or second respective traffic data provides feedback about potential traffic encountered along a route, thereby reducing user input to manually obtain such traffic data.

In some embodiments, the transit information includes respective map data corresponding to one or more public transportation routes, such as route 832 as shown in FIG. 8K, within the first respective map and timing information associated with the one or more public transportation routes, such as the timetable included in banner 806 as shown in FIG. 8K. For example, the transit information optionally includes one or more public transportation routes (e.g., for a bus, tram, train, subway, shuttle, ferry, and/or other mode of public transportation). In some embodiments, the transit information additionally includes one or more timetables along respective routes of respective modes of public transportation. In some embodiments, the traffic information includes information about delays and/or route closures available when the input to obtain the first respective map was received. In some embodiments, the transit information additionally includes metadata such that the electronic device is able to display representations of respective routes of a respective mode of transportation concurrently, each route distinguished with a visual characteristic having a unique value (e.g., color) such that the user can view all available routes within the first respective map. Including public transportation routes and/or timing information associated with the one or more public transportation routes reduces the need for manual input to obtain such routes and allows the user to preview multiple modes of transportation while minimizing the need to communicate requests for additional data.

In some embodiments, the transit information includes respective map data corresponding to a plurality of modes of transportation within the first respective map, such as the representations of modes of transportation within banner 806 as shown in FIG. 8H. For example, the transit information optionally includes information associated with various modes of transportation such as walking, public transportation, driving, cycling, and/or other suitable modes of transportation. The transition information optionally includes routes for the respective modes of transportation (e.g., bike trails, running trails, hiking trails, footpaths, bus lines, and/or subway lines). In some embodiments the transit information includes information such that the electronic device provides estimated times of arrival for the various modes of transportation. Thus, the electronic device provides a mapping experience using the first map data that includes the respective map data that is feature rich, without requiring additional communication to retrieve additional data. Including transit information about a plurality of modes of transportation allows the user to browse and preview various routes and approaches to movement within the first respective map without communication for additional map data.

In some embodiments, the plurality of modes of transportation does not include a respective mode of transportation corresponding to a ride sharing application associated with the electronic device, such as shown in banner 806 in FIG. 8H. For example, the respective mode of transportation corresponds to one or more ride hailing applications that match the user of the electronic device with a second user of a second electronic device, similar to an application based taxicab. In some embodiments, while the electronic device does not satisfy the one or more criteria described as described herein, the electronic device communicates one or more requests for respective data to enable display of transit information associated with the ride sharing application. In some embodiments, while the electronic device satisfies the one or more criteria, the electronic device does not include the respective mode of transportation. For example, if the electronic device optionally has map data that optionally does not include an updated position of an electronic device associated with a ride sharing provider, it optionally is not advantageous for the electronic device to transmit requests hailing the electronic device associated with the ride sharing provider. Excluding the respective mode of transportation from the plurality of modes of transportation reduces the likelihood that user input erroneously attempts to interact with the respective mode of transportation while such interaction may be operating on out-of-date data and/or with services that optionally are not accessible to the electronic device.

In some embodiments, the first map data and the second map data include respective elevation information of respective portions of the first respective map and the second one or more supplemental maps, such as the elevation information included in banner 806 as shown in FIG. 8G. For example, the first map data and/or the second map data include respective topographic information to display elevation information associated with regions of the first respective map and/or the second one or more supplemental maps. For example, the electronic device after receiving the first and/or second map data optionally receives an input requesting display of information associated with a portion of the first respective map and/or a respective supplemental map, such a visual representation of a respective supplemental map—referred to herein as an “information card”—that includes respective information associated with the respective supplemental maps. It is understood that the electronic device optionally displays respective informational cards for various points of interest, trails, supplemental maps, and/or primary maps (e.g., the first respective map), for example. In the information card of the respective supplemental map, the electronic device optionally displays one or more graphs depicting variations of elevation through the supplemental map. In some embodiments, the electronic device displays the respective supplemental map, and includes satellite images and/or graphical representations (e.g., contour lines) of the respective supplemental map. In some embodiments similarly treatment of elevation data is afforded to the first respective map. In some embodiments, the electronic device displays an information card of a respective POI such as a trail, and optionally displays a graph depicting the elevation changes along the trail in accordance with the respective topographic information. In some embodiments, the electronic device displays one or more contour maps (e.g., of the first respective map and/or of a respective supplemental map) in accordance with the topographic information. In some embodiments, the elevation information optionally is used to determine one or more trails and to estimate one or more estimated travel times along such trails for various modes of transportation optionally including cycling, walking, and/or hiking. Including respective elevation information reduces the need for user input to manually obtain such elevation information.

In some embodiments, after receiving the first map data, the electronic device receives, via the one or more input devices, a second input including a request to display a representation of a map (e.g., the first respective map and/or a respective supplemental map of the one or more supplemental maps), such as the request as shown by contact 810 in FIG. 8F. For example, the second input optionally includes a query and/or a selection of a respective map.

In some embodiments, in response to the second input, the electronic device displays, via the display generation component, the representation of the map including a first portion of the representation of the map, such as a portion of the map shown in user interface 824 surrounded by border 828 in FIG. 8G, that corresponds to the first respective map and a second portion of the representation of the map that does not correspond to the first respective map, different from the first portion of the representation of the map, such as the portion of the map outside border 828 as shown in FIG. 8G, wherein the second portion of the representation of the map is visually distinguished from the first portion of the representation of the map. For example, the electronic device optionally displays a representation of a map including the city of Cupertino (e.g., the first portion of the representation corresponding to the first respective map) and optionally distinguishes a region of the environment surrounding Cupertino (e.g., the second portion of the representation other than the first portion). The electronic device optionally visually distinguishes the area surrounding the region around Cupertino with a reduced visual prominence, such as with a particular colorspace, an amount of a blurring effect, a translucency, one or more colors, and/or other visual effects that are different from (e.g., not applied to, or applied to a lesser or great degree than) as applied to the first portion of the representation. In some embodiments, the displayed information (e.g., representations of buildings, roads, streets, and/or other information included in a representation of a map) is more detailed in the first portion of the representation than in the second portion of the representation. For example, the first portion of the representation optionally displays additional side streets that the electronic device would otherwise forgo display of if such side streets were included in the second portion of the representation. Similarly, representations of buildings within the first portion optionally are more defined (e.g., in accordance with the real world dimensions of the buildings) than if the buildings were within the second portion of the representation (e.g., represented by generic rectangular representations). Visually distinguishing the second portion of the representation of the map guides the user's visual focus toward the first portion of the representation, thereby guiding user input toward the first portion of the representation and reducing the likelihood input is erroneously directed to the second portion of the representation, or vice-versa.

In some embodiments, the visual distinguishing includes displaying a representation of a border, such as border 838 as shown in FIG. 8J around the first portion of the representation of the map and displaying the second portion of the representation of the map with a visual effect different from a border of the second portion, wherein the first portion is not displayed with the visual effect. For example, a border surrounding the first portion of the representation of the map is displayed with a color, saturation, hue, brightness, and/or visual effect to distinguish the first portion of the representation from the second portion. Displaying a border distinguishing the second portion of the representation of the map guides the user's visual focus toward the first portion of the representation, thereby guiding user input toward the first portion of the representation and reducing the likelihood input is erroneously directed to the second portion of the representation, or vice-versa, and further indicates a boundary outside of which the first map data may not provide information.

In some embodiments, the visual distinguishing includes displaying the first portion of the representation with a respective visual characteristic having a first value and displaying the second portion of the representation with the respective visual characteristic having a second value, different from the first value, such as a color of the map included in user interface 824 as shown in FIG. 8G. For example, the respective visual characteristic optionally is an amount of blurring effect, visual effect, a color, brightness, saturation, hue, and/or colorspace, and the respective value optionally is a correspond degree and/or value of the respective visual characteristic. For example, the first portion of the representation optionally is displayed without a blurring effect while the second portion of the representation optionally is displayed with a greater degree of the blurring effect (e.g., 0, 5, 10, 15, 20, 30, 40, 50, 60, 70, 80, or 90% blurred). As another example, the first portion of the representation optionally is displayed with a first colorspace and the second portion of the representation optionally is displayed with a shifted (e.g., grayscale) version of the colorspace. Displaying the first portion of the representation and the second portion with respective levels of a respective visual characteristic aids in distinguishing the second portion of the representation of the map guides the user's visual focus toward the first portion of the representation, thereby guiding user input toward the first portion of the representation and reducing the likelihood input is erroneously directed to the second portion of the representation, or vice-versa

In some embodiments, the electronic device receives, via the one or more input devices, a second input, different from the input, including a request to display a representation of a respective supplemental map of the second one or more supplemental maps, such as contact 810 as shown in FIG. 8F (e.g., similar to as described with reference to the second input as described herein). For example, the electronic device optionally receives the second input optionally including a selection of a selectable option in a respective information card for the first respective map and corresponding to the respective supplemental map. For example, the electronic device optionally displays an information card for the San Francisco Bay Area (e.g., the first respective map optionally is a map of the SF Bay Area) and receives a selection of a respective selectable option directed to the city of Cupertino (e.g., the respective supplemental map associated with the first respective map optionally is a map of Cupertino).

In some embodiments, in response to the second input in accordance with a determination that the electronic device satisfies one or more criteria (e.g., similar to as described herein), in accordance with a determination that the electronic device has downloaded the second map data associated with the second one or more supplemental maps, such as the map shown in FIG. 8G, and has downloaded the first map data associated with the first respective map, such as the map shown in FIG. 8E, the electronic device displays, via the display generation component, the representation of the respective supplemental map of the second one or more supplemental maps using the second map data (e.g., similar to as described with reference to the determination that the electronic device has received first map data associated with the first portion of the route with reference to method 700). For example, the electronic device optionally determines that the second map data has previously been downloaded and optionally that the first map data has been downloaded. For example, the electronic device optionally displays a map of the city of Cupertino that optionally was obtained when first map data corresponding to a map of the San Francisco Bay area was optionally obtained. In some embodiments, the electronic device displays the representation of the respective supplemental map using the second map data, which optionally was stored locally when received, and does not display the respective supplemental map using third map data that is streamed to the electronic device in real-time, or nearly real time, where the third map data is received at least partially after the second input is received.

In some embodiments, in accordance with a determination that the electronic device has not downloaded the second map data associated with the second one or more supplemental maps, forgoing the displaying of the representation of the respective supplemental map of the second one or more supplemental maps using the second map data, such as forgoing the display of the map shown in FIG. 8G. For example, the electronic device optionally does not display the representation of the respective supplemental map at all. In some embodiments, the electronic device communicates a request for third map data (as described previously) in response to the second input, and later displays a similar representation of the respective supplemental map using the third map data. Thus, the electronic device optionally uses the second map data—stored local to the electronic device—or uses third map data—streamed and/or received at the electronic device after the second input is received—to display the representation of the respective supplemental map. Displaying or forgoing display of the respective supplemental map using the second map data based on if the electronic device optionally has downloaded or has not downloaded the second map data reduces the processing required attempting to display the respective supplemental map with the requisite data being stored locally.

In some embodiments, the displaying the representation of the respective supplemental map of the second one or more supplemental maps using the second map data includes displaying respective information describing one or more characteristics associated with the respective supplemental map, such as information in banner 806 as shown in FIG. 8G. For example, as described previously as described herein, the electronic device optionally displays respective information such as an information card describing the respective supplemental map. In some embodiments, the respective information is different from information included in the first map data. For example, the information card of the supplemental map optionally includes one or more characteristics associated with the supplemental map such as user ratings, contact information, operating hours, wheelchair accessibility, pet friendliness, acceptance of credit cards, and other information of potential interest to a user of the electronic device, and as described further with reference to method 700. In some embodiments, the information card includes one or more selectable options that are respectively selectable to view information cards of related respective supplemental maps of the second one or more supplemental maps. Including respective information describing the respective supplemental map in the second map data reduces the need for user input to manually obtain such data and/or power consumption required to transmit additional requests for such information.

In some embodiments, while the electronic device satisfies the one or more criteria (e.g., similar to as described herein), while displaying, via the display generation component, at least a portion of the respective supplemental map based on the second map data, such as the map shown in FIG. 8G, the electronic device receives, via the one or more input devices, a third input, other than the second input and the input, including a request to search for a point of interest included within the respective supplemental map, such as the contact 810 as shown in FIG. 8L. For example the third input optionally includes a selection of a search field displayed in the user interface, and optionally includes entry of a search query, such as a name of a region and/or a keyword.

In some embodiments, in response to receiving, via the one or more input devices, the third input including the request to search for the point of interest, the electronic device displays, via the display generation component, one or more representations of one or more respective points of interest in the portion of the respective supplemental map based on the request to search using the second map data, such as representation 850-1. For example, the electronic device optionally determines one or more respective points of interest (POI) that optionally correspond to the query using the second map data. For example, the electronic device optionally receives a query for parks while displaying a regional map of Cupertino, where the map of Cupertino optionally corresponds to the respective supplemental map, and in response to receiving the query, optionally displays one or more representations of parks that are within the bounds of the regional map of Cupertino at respective locations corresponding to the respective parks, optionally (solely) using the second map data.

In some embodiments, while displaying the one or more representations of the one or more respective points of interest in the portion of the respective supplemental map, receiving, via the one or more input devices, a fourth input, different from the third input, the second input and the input, selecting a first representation of the one or more representations of the one or more respective points of interest corresponding to a first point of interest, such as contact 610 as shown in FIG. 6E. For example, the electronic device optionally receives a selection input corresponding to a respective representation of the one or more points of interest. Alternatively, in some examples, the electronic device receives selection of a second point of interest, different from the first.

In some embodiments, in response to the fourth input, the electronic device displays, via the display generation component, respective information describing one or more characteristics associated with the first point of interest, wherein the respective information is included in the second map data, such as information included in banner 622 as shown in FIG. 6G. In some embodiments, in response to selection of the second point of interest, the electronic device displays respective information associated with the second point of interest. The respective information optionally includes the information card corresponding to the respective point of interest. Displaying respective information describing one or more characteristics of the first point of interest that is included in the second map data reduces the need for manual input to obtain such information and the power consumption required to transmit additional requests for such information.

In some embodiments, the displaying, via the display generation component, of the respective information describing the one or more characteristics associated with the first point of interest includes visually distinguishing respective representations of routes, such as portion 826 as shown in FIG. 8H, corresponding to the first point of interest within the respective supplemental map using the second map data. For example, the point of interest optionally is a landmark, and the information card associated with the landmark describes one or more hiking trails passing through/leading to the landmark. In some embodiments, the electronic device optionally also visually distinguishes the one or more hiking trails on the representation of the respective supplemental map (e.g., similar to as described with reference to the border as described herein). Additionally or alternatively, the electronic device visually distinguishes routes such as public transportation routes, shuttle lines, and/or other relevant routes associated with a respective POI. Visually distinguishing one or more representations of routes corresponding to the first point of interest visually guides users toward such routes and facilitates more efficient evaluation of such routes, thereby reducing the need for manual input to locate and/or compare such routes.

In some embodiments, the respective information includes one or more landmarks, elevation information, and qualities of one or more roads included within the respective supplemental map such as shown in banner 806 as shown in FIG. 8G. For example, the respective information optionally includes information (e.g., graphical and/or textual) of one or more lands marks such as a respective icon of a landmark. In some embodiments, the elevation has one or more characteristics of the elevation information described as described herein. In some embodiments, the respective information includes visual distinguishing of one or more roads to indicate the quality of the roads (e.g., paved, unpaved, and passing through bodies of shallow water). Such information optionally includes an overlay over a respective representation of the supplemental map, text labelling and/or describing such information, and/or separate representations (e.g., in an information card) of such respective information. Including landmarks, elevation, and road quality in the respective supplemental map better informs the user as to the contents of the map without requiring user input to obtain such respective information.

In some embodiments, the respective information includes information associated with a strength of a wireless network associated with the electronic device, such as a network of the electronic device 500 as shown in FIG. 8A. For example, the respective information describes one or more characteristics of a communication network (e.g., wireless network) associated with the electronic device. For example, the one or more characteristic optimally correspond to the one or more characteristics of the respective criterion described as described herein. In some embodiments, the electronic device uses such network information to display a representation of coverage of the communication network. For example, the respective information describes cellular coverage of a carrier of the electronic device, and the electronic device displays a “heatmap” of the cellular coverage within the respective supplemental map. For example, the electronic device displays a range visual characteristics including colors, saturations, brightness, and/or hues, such that respective locations with relatively strong network coverage are displayed with a first appearance (e.g., bright red), and respective locations with relatively weak network coverage are displayed with a second appearance (e.g., bright purple), and intermediate levels of network coverage are arranged along a continuum of the range of colors (e.g., yellow for moderate network coverage). Including information associated with a wireless network of the electronic devices indicates network coverage a user of the electronic device can expect in such an area, thereby informing the user as to where they can expect data coverage and/or will have to rely on locally stored data.

In some embodiments, while displaying, via the display generation component, a visual representation of a point of interest including respective information describing one or more characteristics associated with the point of interest (e.g., an icon representing the POI and a respective information card), such as shown in user interface 824 as shown in FIG. 8E, wherein the point of interest is associated with the first respective map, and while not displaying the one or more visual representations corresponding to the first one or more maps, receiving, via the one or more input devices, a second input, different from the first input, including a request to download the first map data associated with the first respective map, such as contact 810-1 shown in FIG. 8E. For example, the electronic device separately receives an express request to download the first map data that is separate from a user interface displaying one or more suggested maps (e.g., visual representations corresponding to first one or maps as described herein), such as a selection input of a selectable option to download map data corresponding to the first respective map. For example, a user of the electronic device while connected to a communication network optionally queries to obtain a representation of a search result corresponding to the first respective map, and optionally is presented with an information card corresponding to the first respective map in response to a selection of a repetition of the first respective map. The electronic device optionally receives selection of a respective selectable option included in the information card, and in response to the selection input, optionally downloads the first respective map.

In some embodiments, in response to receiving, via the one or more input devices, the second input, the electronic device transmits a second request, different from the request, to download the first map data associated with the first respective map, such as request for supplemental map data to display user interface 824 in FIG. 8G, (e.g., having one or more characteristics of the request to download the first map data described as described herein).

In some embodiments, in accordance with a determination that the second one or more supplemental maps, other than the first one or more maps, are associated with the first respective map, transmitting a third request, different from the second request, to download the second map data associated with the second one or more supplemental maps such as the map shown in user interface 824 as shown in FIG. 8G. (e.g., having one or more characteristics of the determination described as described herein). Thus, in some embodiments, the electronic device allows the user to obtain the first map data and the second map data from a user interface suggesting the first respective map to the user based on the user's history, and from other user interfaces that are not expressly displayed based on the user's history. Providing multiple entry points to obtain the first map data and the second map data allow flexibility such that the user can efficiently obtain such data at their discretion, thereby reducing inputs requiring the user to manipulate the user interface, for example, to display a suggestion user interface.

In some embodiments, the point of interest is associated with third one or more supplemental maps, different from the second one or more supplemental maps and the first one or more maps, and the third request to download the second map data associated with the second one or more supplemental maps does not include a respective request to download third map data associated with the third one or more supplemental maps, such as a map associated with a representation 850-2 as shown in FIG. 8N and representation 618-2 as shown in FIG. 6E. In some embodiments, as described herein, the electronic device optionally delineates between portions of a representation of a map. For example, the electronic device optionally displays a map including a first portion optionally corresponding to a first respective map, such as a map of Cupertino. In some embodiments, the electronic device optionally also identifies a second portion of the map, such as a region surrounding Cupertino, that optionally does not correspond to the first respective map. Instead, the second portion of the map optionally includes and/or corresponds to one or more supplemental maps (e.g., third one or more supplemental maps), for example, maps of trails in Saratoga. As such, when the electronic device receives an input (e.g., the second input) to download the first map data corresponding to the first portion of the map (e.g., and optionally also including supplemental maps within the first portion of the map such as trails within Cupertino), the electronic device optionally does not also download map data corresponding to the second portion of the map (e.g., including the supplemental maps corresponding to trails in Saratoga). In some embodiments, a point of interest such as a scenic lookout optionally is associated with the supplemental maps including trails in Cupertino and optionally is also associated with the supplemental maps corresponding to trails in Saratoga. For example, the point of interest optionally intersects a trail having a trailhead starting within Cupertino, and a second trailhead starting within Saratoga. In response to a request to download the map data including Cupertino and its respective trails, the electronic device optionally determines that the scenic lookout—although associated with trails in Cupertino—is outside the bounds of the first portion of the map (e.g., is outside of Cupertino) and optionally forgoes download of map data corresponding to the scenic lookout, and optionally forgoes download of respective map data of the trails in Saratoga. Thus, in response to the request to download the map data, the computer system optionally obtain respective map data including map data of areas within Cupertino optionally in addition to one or more trails within Cupertino. Excluding download of supplemental maps despite an association with a point of interest limits the amount of data and processing required to obtain first map data and second supplemental map data, thereby reducing power consumption and speeding up retrieval of the first and the second map data.

It should be understood that the particular order in which the operations in FIG. 9 has been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 9 is, optionally, implemented by components depicted in FIGS. 1A-1B. For example, displaying operation 902a, selecting operation 902b, transmitting operation 902d, and transmitting operation 902e are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the suggesting of maps based on a history of user interaction and the obtaining of one or more maps in response to input to download a respective map. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to identify the location of the user. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide personal data and/or device or object location data. In yet another example, users can select to limit the length of time personal data and/or device or object location data is maintained or entirely block the development of a baseline location profile. In addition to providing “opt in” and “opt out” options, the present disclosure contemplates providing notifications relating to the access or use of personal information. For instance, a user may be notified upon downloading an application that their personal information data and/or location data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more input devices and a display generation component:
receiving, via the one or more input devices, user input initiating navigation along a route, wherein the route includes a first portion of the route that is within a first geographic region and a second portion of the route that is within a second geographic region, different from the first geographic region;
in response to receiving the user input initiating the navigation along the route, initiating the navigation along the route;
while the navigation along the route is initiated and before the navigation along the route reaches the first portion of the route or the second portion of the route:
in accordance with a determination that the first portion of the route satisfies one or more criteria:
transmitting a first request for first map data associated with the first portion of the route; and
after transmitting the first request for the first map data, receiving the first map data associated with the first portion of the route;
in accordance with a determination that the second portion of the route satisfies the one or more criteria:
transmitting a second request for second map data associated with the second portion of the route; and
after transmitting the second request for the second map data, receiving the second map data associated with the second portion of the route;
while the navigation along the route is initiated:
in accordance with a determination that a position of a user of the electronic device corresponds to the first portion of the route:
in accordance with a determination that the electronic device has received the first map data associated with the first portion of the route, continuing navigation using the received first map data; and
in accordance with a determination that the electronic device has not received the first map data associated with the first portion of the route, receiving third map data streaming to the electronic device and continuing navigation using the third map data; and
in accordance with a determination that the position of the user of the electronic device corresponds to the second portion of the route:
in accordance with a determination that the electronic device has received the second map data associated with the second portion of the route, continuing navigation using the received second map data; and
in accordance with a determination that the electronic device has not received the second map data associated with second portion of the route, receiving fourth map data, different from the third map data, streaming to the electronic device and continuing navigation using the fourth map data.

2. The method of claim 1, wherein the one or more criteria include a criterion that is satisfied in accordance with a determination that a location of the electronic device is within a threshold distance of the first portion of the route, the method further comprising:
in accordance with the determination that the first portion of the route satisfies the one or more criteria:
displaying, via the display generation component, a selectable option that is selectable to transmit the first request for the first map data associated with the first portion of the route; and
receiving, via the one or more input devices, a first input, other than the user input, selecting the selectable option; and
in response to receiving, via the one or more input devices, performing the transmitting of the first request for the first map data associated with the first portion of the route.

3. The method of claim 1, further comprising:
while the navigation along the route is initiated:
in accordance with the determination that the position of the user of the electronic device corresponds to the first portion of the route and in accordance with the determination that the electronic device has received the first map data associated with the first portion of the route, displaying, via the display generation component, a visual indication indicative of the use of the received first map data to continue the navigation.

4. The method of claim 1, wherein the first map data includes data for one or more points of interest (POI) that satisfy one or more second criteria, including a criterion that is satisfied when the one or more POI are within a threshold distance of the first portion of the route.

5. The method of claim 4, wherein the one or more second criteria include a criterion that is satisfied based on one or more factors associated with a communication network of the electronic device in areas between the one or more POI and the first portion of the route.

6. The method of claim 1, wherein a respective POI is associated with the first portion of the route, the method further comprising:
while the navigation along the route is initiated:
receiving, via the one or more input devices, a first input corresponding to a request to view information associated with the respective POI; and
in response to receiving, via the one or more input devices, the first input:
in accordance with the determination that the electronic device has received the first map data, displaying, via the display generation component, the information associated with the respective POI using the first map data; and
in accordance with the determination that the electronic device has not received the first map data, displaying, via the display generation component, the information associated with the respective POI using the third map data streaming to the electronic device.

7. The method of claim 1, wherein the first map data and the second map data include information associated with a history of traffic along the first portion of the route and the second portion of the route, respectively.

8. The method of claim 1, wherein the first map data and the second map data include information associated with one or more route closures along the route present at a time the user input initiating the navigation along the route is received.

9. The method of claim 1, further comprising:
while the navigation along the route is initiated and while the position of the user corresponds to the first portion of the route and the first portion of the route satisfies the one or more criteria, receiving, via the one or more input devices, a first input adding navigation toward a respective POI associated with the first portion of the route to the navigation along the route; and
in response to receiving, via the one or more input devices, the first input, modifying the navigation along the route to include navigation toward the respective POI.

10. The method of claim 1, wherein the one or more criteria include a criterion that is satisfied when a respective portion of the route is within a threshold distance of a destination of the route.

11. The method of claim 1, wherein the one or more criteria include a criterion that is satisfied based on one or more characteristics of a respective portion of a communication network of the electronic device along a respective portion of the route.

12. An electronic device that is in communication with one or more input devices and a display generation component, the electronic device comprising:
one or more processors;
memory; and
one or more programs, wherein the one or more programs are stored in the memory and are configured to be executed by the one or more processors, the one or more programs including instructions for:
receiving, via the one or more input devices, user input initiating navigation along a route, wherein the route includes a first portion of the route that is within a first geographic region and a second portion of the route that is within a second geographic region, different from the first geographic region;
in response to receiving the user input initiating the navigation along the route, initiating the navigation along the route;
while the navigation along the route is initiated and before the navigation along the route reaches the first portion of the route or the second portion of the route:
in accordance with a determination that the first portion of the route satisfies one or more criteria:
transmitting a first request for first map data associated with the first portion of the route; and
after transmitting the first request for the first map data, receiving the first map data associated with the first portion of the route;
in accordance with a determination that the second portion of the route satisfies the one or more criteria:
transmitting a second request for second map data associated with the second portion of the route; and
after transmitting the second request for the second map data, receiving the second map data associated with the second portion of the route;
while the navigation along the route is initiated:
in accordance with a determination that a position of a user of the electronic device corresponds to the first portion of the route:
in accordance with a determination that the electronic device has received the first map data associated with the first portion of the route, continuing navigation using the received first map data; and
in accordance with a determination that the electronic device has not received the first map data associated with the first portion of the route, receiving third map data streaming to the electronic device and continuing navigation using the third map data; and
in accordance with a determination that the position of the user of the electronic device corresponds to the second portion of the route:
in accordance with a determination that the electronic device has received the second map data associated with the second portion of the route, continuing navigation using the received second map data; and
in accordance with a determination that the electronic device has not received the second map data associated with second portion of the route, receiving fourth map data, different from the third map data, streaming to the electronic device and continuing navigation using the fourth map data.

13. A non-transitory computer readable storage medium storing one or more programs, the one or more programs comprising instructions, which when executed by one or more processors of an electronic device that is in communication with one or more input devices and a display generation component, cause the electronic device to perform a method comprising:
receiving, via the one or more input devices, user input initiating navigation along a route, wherein the route includes a first portion of the route that is within a first geographic region and a second portion of the route that is within a second geographic region, different from the first geographic region;
in response to receiving the user input initiating the navigation along the route, initiating the navigation along the route;
while the navigation along the route is initiated and before the navigation along the route reaches the first portion of the route or the second portion of the route:
in accordance with a determination that the first portion of the route satisfies one or more criteria:
transmitting a first request for first map data associated with the first portion of the route; and
after transmitting the first request for the first map data, receiving the first map data associated with the first portion of the route;
in accordance with a determination that the second portion of the route satisfies the one or more criteria:
transmitting a second request for second map data associated with the second portion of the route; and
after transmitting the second request for the second map data, receiving the second map data associated with the second portion of the route;
while the navigation along the route is initiated:
in accordance with a determination that a position of a user of the electronic device corresponds to the first portion of the route:
in accordance with a determination that the electronic device has received the first map data associated with the first portion of the route, continuing navigation using the received first map data; and
in accordance with a determination that the electronic device has not received the first map data associated with the first portion of the route, receiving third map data streaming to the electronic device and continuing navigation using the third map data; and
in accordance with a determination that the position of the user of the electronic device corresponds to the second portion of the route:
in accordance with a determination that the electronic device has received the second map data associated with the second portion of the route, continuing navigation using the received second map data; and
in accordance with a determination that the electronic device has not received the second map data associated with second portion of the route, receiving fourth map data, different from the third map data, streaming to the electronic device and continuing navigation using the fourth map data.

14-42. (canceled)
